(19) United States
(12) Patent Application Publication
(10) Pub. No.: US 2025/0339891 A1
(43) Pub. Date: Nov. 6, 2025

(54) Container Processing Equipment

(71) Applicant: 202008 LIMITED, Auckland (NZ)

(72) Inventors: Benjamin Caleb Jarrett, Whangateau (NZ); Ronald Andrew Young, Auckland (NC); Joshua Adam Stewart, Auckland (NZ)

(73) Assignee: 202008 LIMITED, Auckland (NZ)

(21) Appl. No.: 18/869,085

(22) PCT Filed: May 25, 2022
(86) PCT No.: PCT/NZ2022/050060

§ 371 Date: Nov. 25, 2024

(51) Int. Cl. B21D 51/26; B21D 51/32; B65B 7/28; B65B 43/52; B65B 59/00

(52) U.S. Cl. CPC B21D 51/2661; B21D 51/2692; B21D 51/32; B65B 7/2807; B65B 7/2857; B65B 43/52; B65B 59/001

(57) ABSTRACT

Container processing equipment, particularly for processing of food/beverage cans requires filling and sealing. A can seaming system may include interchangeable seaming chucks. A seaming system may be calibrated by sensing a relative position between a seaming spindle and a seaming roller. Conveyor systems may move container axes along a conveyor path irrespective of container size. Conveyors may include container bearers that are mounted for rotational motion allowing containers to enter and/or exit the conveyor. In beverage packaging, inert gas and beverage may be introduced into a container through a single fill conduit. A fill system may include a moving fill conduit arranged to deliver beverage to a lower region of the container. A closure system may include bulk and intermediate closure holders, for feeding closures to a closure head.

### FIELD OF THE INVENTION

The invention relates to the processing of containers, for example the filling and/or closing and/or sealing of containers. The invention relates mainly but not exclusively to the processing of containers for beverages or foodstuffs.

### BACKGROUND

In packaging of foodstuffs, cans, tins, jars, bottles or other containers may be used, formed from steel, aluminium, other metals, plastics, glass, or other suitable materials. Containers used in packaging of beverages include cans (usually of aluminium) and bottles (glass or plastic).

Processing containers for foodstuffs or beverages generally includes filling and sealing the containers. The quality of the processing steps may have a marked effect on the preservation or shelf life of the container contents. Depending on the container contents, it may be desirable to exclude oxygen or air.

Some containers may be sealed by the application of a threaded closure (such as a jar or bottle lid). Other containers require the formation of a seam. For example, beverage cans are sealed by the formation of a seam between the can body and a closure in the form of a can end or lid.

More than 2 trillion beverage cans are believed to be sold globally each year, over 70% of which are made from aluminium. Cans have several advantages over other packaging types (glass bottles, PET bottles, tetrapaks, etc.). They are light, light-proof, robust, more easily transported, have large surface areas available for graphics, chill faster and are recyclable.

Beverage cans are generally processed in factory settings. However, there is also now a micro canning industry, requiring canning at small or irregular throughputs. Both factory processing and micro canning equipment suffers from several problems. Brewers & beverage makers may struggle to achieve consistent quality output. Canning specialists may be required to oversee canning and/or calibrate equipment. Further, existing machinery is generally set up to process a limited number of can sizes and lid types.

Beverage can fillers generally use one of two filling typologies-open fill and counter pressure. In both cases, the elimination of oxygen is a primary concern. Both types of design generally require intensive operator interaction and manual adjustment to produce high quality outputs.

Industrial high-volume machines use counter pressure techniques where the can is sealed, purged with CO₂ and filled in a controlled atmosphere. These machines process very high volumes and are capable of filling cans with still and carbonated drinks to a consistent quality.

Open fill machines are typically used by craft brewers who need to process smaller volumes (e.g. 6 to 80 cans per minute—‘cpm’). These machines are derived from manual filling processes and may be capable of filling beverages to an acceptable standard if constantly monitored by an experienced operator during the entire filling process. These machines rely upon foam from carbonated drinks to protect the beverage from ambient oxygen and are therefore unable to process still drinks to a consistent quality.

As consumers have increasingly transitioned to craft beers and smaller batch-produced canned drinks (coffee, kombucha, seltzer, etc.), the need for beverage manufacturers to process smaller volumes has significantly increased.

It would be desirable to provide improvements in container processing, or at least to provide the public with a useful choice.

### SUMMARY

A can seaming system may include a spindle assembly including a seaming chuck mounted on a seaming spindle. A seaming roller assembly may include one or more seaming rollers configured to cooperate with the seaming chuck to form a seam between a can body and a can end, the one or more seaming rollers each configured to move through a range of motion from a disengaged position to an end position; and one or more actuators configured to move each of the one or more seaming rollers through its range of motion. Calibrating the can seaming system may include sensing a relative position between a first reference surface of the spindle assembly and a second reference surface of the seaming roller assembly. A controller may control the one or more actuators based at least in part on the sensed relative position.

Sensing the relative position may include sensing contact of the first and second reference surfaces. Sensing contact may include sensing electrical connection. Alternatively, sensing contact may include sensing an electrical load on one or more of a spindle motor and a seaming roller actuator.

Sensing the relative position may be performed by an optical sensor.

A calibration value may be stored based on the sensed relative position and the controller may control the one or more actuators based at least in part on the stored calibration value.

A second relative position between a third reference surface of the spindle assembly and a fourth reference surface of the seaming roller assembly may be sensed. The relative vertical positions of the spindle assembly and/or seaming roller assembly may be adjusted based on the second relative position.

A can seaming system may be configured to form a seam between a can body and a closure to create a seamed can. The system may include: a spindle assembly including a seaming chuck mounted on a seaming spindle, the spindle assembly including a first reference surface. The system may also include a seaming roller assembly including: one or more seaming rollers configured to cooperate with the seaming chuck to form a seam between a can body and a can end, the one or more seaming rollers each configured to move through a range of motion from a disengaged position to an end position; a second reference surface; and one or more actuators configured to move each of the one or more seaming rollers through its range of motion. A calibration sensor may be configured to sense a relative position between the first reference surface and the second reference surface of the seaming roller assembly. A controller may be configured to control the one or more actuators based at least in part on the sensed relative position.

The calibration sensor may include one or more of: an electric connection sensor; a load sensor; and an optical sensor.

A third reference surface may be provided on the spindle assembly and a fourth reference surface on the seaming roller assembly, the calibration sensor being configured to sense a second relative position between the third reference surface and the fourth reference surface, the controller being configured to adjust the relative vertical positions of the spindle assembly and/or seaming roller assembly based on the second relative position.

A can seaming system may be configured to form a seam between a can body and a closure to create a seamed can, the system being configured to seam two or more types or sizes of can. The system may include a seaming spindle having a rotational axis and two or more interchangeable seaming chucks. Each of the two or more seaming chucks may be configured for use with a different can type. Each of the two or more seaming chucks may be configured for mounting to the seaming spindle. One or more seaming rollers may be configured to cooperate with the mounted seaming chuck to form a seam between a can body and a closure.

The seaming spindle may incorporate a machine taper.

A seaming chuck holder may be configured to mount to the machine taper, each seaming chuck being configured to mount to the seaming chuck holder.

An axis of a mounted seaming chuck may be aligned with the rotational axis of the spindle.

Each of the two or more seaming chucks may include a registration surface configured to bear against a cooperating registration surface of the seaming spindle, to register a position of that seaming chuck along the rotational axis of the seaming spindle.

The one or more seaming rollers may each be configured to move through a range of motion from a disengaged position to an end position; the system including one or more actuators configured to move each of the one or more seaming rollers through its range of motion.

A single actuator may be configured to rotate a cam that acts to move each of the one or more seaming rollers through its range of motion. The single actuator may be a servo motor.

The can seaming system may include two or more seaming rollers. Two or more seaming rollers may be arranged for double seaming. The can seaming system may be configured for double seaming of aluminium beverage cans.

A feed arrangement may be configured to move filled can bodies and closures into a seaming position.

The system may be configured for relative vertical movement between the can and seaming chuck, to bring the can closure into or out of contact with the seaming chuck.

A container conveyor may include a plurality of container bearers, each being configured to bear a single container along the conveyor path, wherein each of the plurality of container bearers is configured for use with containers of different sizes within a range of acceptable container sizes, each container bearer configured to align a center or axis of any such container with the same conveyor path.

Each container bearer may be configured to contact a container at two points, one on each side of the conveyor path. Each container bearer may have a generally V-shaped profile.

A container conveyor may include one or more bearer carriers and a plurality of container bearers, wherein the one or more bearer carriers are configured to move the plurality of container bearers such that, in use, one or more containers are moved along a conveyor path. Each of the plurality of container bearers may be configured to bear a single beverage container along the conveyor path. Each of the plurality of container bearers may be mounted for rotational movement relative to its respective bearer carrier, for entry and/or exit of a container to/from the conveyor.

The container conveyor may include a guide rail and each container bearer may include a guide element that rides along the guide rail to cause the rotational movement.

A beverage container filling apparatus may include a fill head arranged to temporarily close an opening of a beverage container during filling. A fill conduit may pass through the fill head for introduction of inert gas and beverage into the container. A beverage valve may control flow of beverage from a beverage source to the fill conduit. An inert gas inlet may be provided for introduction of inert gas into the fill conduit at a point downstream of the beverage valve and an inert gas valve controlling flow of inert gas to the inert gas inlet.

The system may include a vent valve.

A controller may be arranged to: control relative movement of a beverage container and fill head, such that the fill head closes the container; control the inert gas valve to cause flow of inert gas into the container, thereby pressurising the container; reduce or cease flow of inert gas, and control the beverage valve to allow flow of beverage into the container; control the vent valve to control the pressure in the container and the flow of beverage into the container; control the beverage valve to cease flow of beverage into the container; control the vent valve to release pressure from the container; and control relative movement of the container and fill head, such that the fill head no longer closes the container. The controller may be configured to reopen the inert gas valve, such that inert gas flows to the top of the filled container.

The fill conduit may be mounted for sliding movement relative to the fill head such that, in use, the fill conduit is arranged for introduction of beverage directly into a lower region of the container and for retraction relative to the fill head during or after filling.

A beverage container filling apparatus may include a fill head arranged to temporarily close an opening of a beverage container during filling. A fill conduit may pass through the fill head and be mounted for sliding movement relative to the fill head such that, in use, the fill conduit is arranged for introduction of beverage directly into a lower region of the container and for retraction relative to the fill head during or after filling. A beverage valve may control flow of beverage from a pressurised beverage source to the fill conduit. A vent valve may be arranged to control pressure in the container and the flow of beverage into the container.

A controller may be arranged to control movement of the fill head and of the sliding movement of the fill conduit.

The controller may be arranged to receive a container classifier and to control the movement of the fill head and/or of the sliding movement of the fill conduit in accordance with the container classifier.

A container closure system may include a container feed arrangement configured to move filled containers into a closure application position and a closure head arranged to apply a closure to a filled container in the closure application position. A closure feeder may be arranged to feed closures to the closure head. The closure feeder may include an intermediate closure holder and a bulk closure holder, wherein the intermediate closure holder is configured to hold one or more closures, to receive closures from the bulk closure holder and feed closures to the closure head.

The bulk closure holder may include a plurality of closure magazines and be arranged to move between a plurality of positions, in each of which one of the plurality of closure magazines is positioned to feed closures to the intermediate closure holder.

The bulk closure holder may be a rotating holder.

The magazines may be adjustable for differently sized closures.

The magazines may be removable for refilling.

An inert gas doser may be configured to provide inert gas to the top of the container before the closure is applied.

The closure head may include two or more closure retainers, each arranged to receive a closure from the intermediate closure holder, wherein the closure head is configured to move between a plurality of positions, in each of which one of the closure retainers is positioned to apply a closure to a filled container. Each closure retainer may include one or more resilient features arranged to retain a closure but to deform to allow the closure to move past the resilient features when it is applied to the container. The closure head may include a bubble breaker arranged to wipe foam from the top of the container before the closure is applied.

The closure head may include one or more inert gas outlets arranged for flow of inert gas to the top of the container before the closure is applied.

A pusher may be arranged to push the closure from the closure head onto the container.

### BRIEF DESCRIPTION OF DRAWINGS

The invention will be described by way of example only, with reference to the accompanying drawings, in which:

FIG. 1 is a schematic view of one embodiment of canning system;

FIG. 2 is a schematic view of a further embodiment of canning system;

FIG. 3 illustrates a pre-clean process;

FIG. 4 illustrates a pre-purge process;

FIGS. 5 to 5G show a container filling system according to one embodiment;

FIG. 6 shows a beverage valve;

FIG. 7 illustrates sensors and valves in one embodiment of filling system;

FIG. 8A to 8G illustrate a filling process according to one embodiment;

FIG. 9 Further illustrates a filling cycle;

FIG. 9A illustrates control of a fill cycle;

FIGS. 10 to 10G show a closure holder or magazine according to one embodiment;

FIG. 11 illustrates a bulk closure holder;

FIGS. 12 to 12J show closure systems;

FIG. 13 shows a can seaming system;

FIGS. 14 and 14A illustrate a double seaming process;

FIGS. 15 to 15E are further views of the seaming system of FIG. 13;

FIGS. 16 to 16C show a seaming chuck and seaming spindle assembly;

FIGS. 17 to 17C illustrate calibration of a seaming system;

FIGS. 18 to 18C illustrate systems for conveying containers; and

FIG. 19 illustrates one embodiment of control system.

### DESCRIPTION OF PREFERRED EMBODIMENTS

The invention will be described below with reference to the processing of beverage cans. However, unless the language of the claims indicates to the contrary, it is not the Applicant's intent to limit the scope of the invention to beverage canning. Aspects of the Applicant's system may find application in packaging of beverages (including still and sparkling/carbonated beverages, alcoholic and non-alcoholic beverages, brewed or non-brewed beverages), foodstuffs or other substances, products or materials. Further, aspects of the Applicant's system may find application in the processing of any suitable containers, including cans, tins, bottles, jars or other suitable containers.

The Applicant's packaging systems are designed to provide high quality packaging results. The systems may be suitable for use by less skilled operators than in traditional industrial scale systems. Further, the Applicant's systems may provide product consistency, machine reliability, easy cleaning processes (CIP Clean-In-Place) and reduced labour costs.

Several features of the Applicant's system may contribute to the resulting high-quality packaging.

Minimisation of dissolved oxygen in the final package reduces degradation of the contents and/or increases shelf life. In some embodiments, dissolved oxygen in the sealed container may be less than 35, or less than 15, or less than 10, parts per billion (ppb).

Careful handling of liquids, such as beverages, may provide reduced turbulence and non-laminar flow during processing. This is particularly important during filling of the container. This reduces the tendency of the liquid to entrain air or oxygen during filling.

Consistent and precise canning processes provide repeatable quality and reduce the need for user adjustment or oversight of the process. In some embodiments the canning processes may be partially or fully automated.

Further, the Applicant's systems provide a user experience that is adaptable to the end user. The process is simple and clear, allowing novice users to quickly produce sealed containers to a high standard (e.g. using presets and basic control features). On the other hand, experienced users may be permitted fine control of some or all parameters.

Various sensors, to be described below, allow control of processing parameters.

Applicant's mechanical design may provide reliability and speed. The system may be modular and/or upgradable such that capacity and/or speed can be raised as production demands increase. Modular componentry may allow users to install replacement modules in the field. A set of modular components may be arranged in various configurations. Each component may be modular and independently controlled—for example the same filler may be used in a number of different machines. This modularity allows a clear upgrade path for manufacturers to scale production with growth and ensure the beverages that they carefully create are always packaged to a high standard.

Materials may be suited to the application. For food and beverage applications, food safe materials should be used. Suitable materials may include 316L stainless steel, PTFE, Food Grade Silicon, etc.)

In some embodiments, quick and accurate changeover between different containers may be provided. For example, the system may be capable of using a variety of can sizes and/or can-end diameters.

Some embodiments may be capable of processing a range of contents-including sparkling, brewed, carbonated, still, pulp-based beverages and dairy products.

Applicant's systems may also provide an integrated clean-in-place processes. This allows assisted or automated cleaning of the system at the end of a packaging run, or when changing from one package content to another.

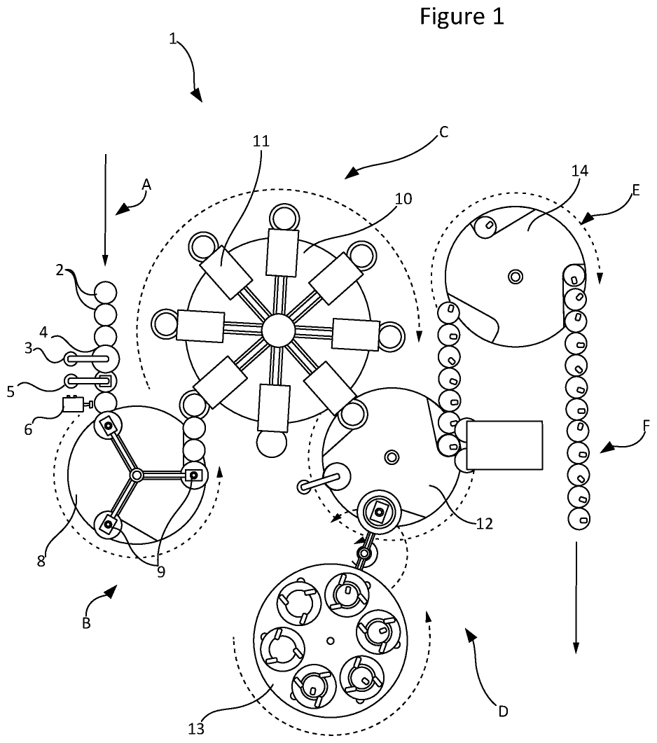

FIG. 1 is a schematic view of a canning system 1 according to one embodiment. In general, the canning system 1 receives an empty can body and a closure, supplies contents to the can body, applies and seals the closure to the can body to produce a filled and sealed can. The system may provide for entry A, pre-fill B, fill C, closure D, sealing E and exit F of containers. These functions will be described in detail below.

FIG. 1 shows empty can bodies 2 entering the system 1. It is important to ensure that there are no contaminants remaining in the can on entry into the system. Possible contaminants include: insects, rodents, dust, spilt liquids, insect matter, etc. Beverage manufacturers may assume that these contaminants are not in the cans distributed by their can supplier when in complete pallets-cans are usually directly packaged after going through the manufacturing process at extremely high temperatures. It is therefore usual practice simply to flush each can with a jet of water-usually in a twist rinse mechanism.

However, partial pallets, or cans left over after a production run, allow for contaminant ingress-including live insects and/or rodents.

Further, the traditional rinsing of the cans with water/cleaning solution directly adds a source of dissolved oxygen to the packaged beverage, reducing the quality of the packaged beverage. Traditional twist rinse systems also position the cans upside down for cleaning, are bulky and generally consume a lot of space. Changeover between different cans may be difficult and/or time consuming.

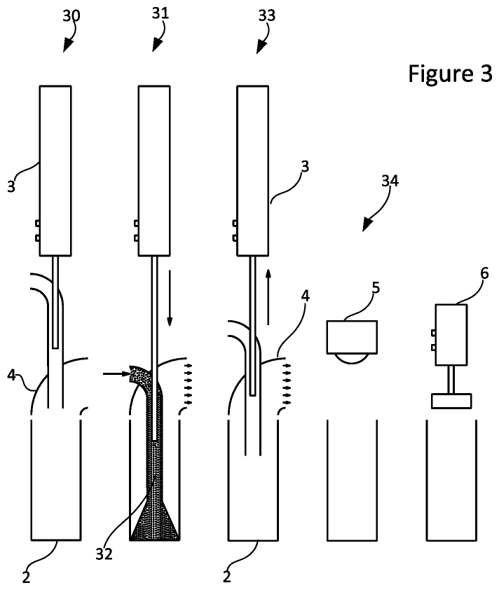

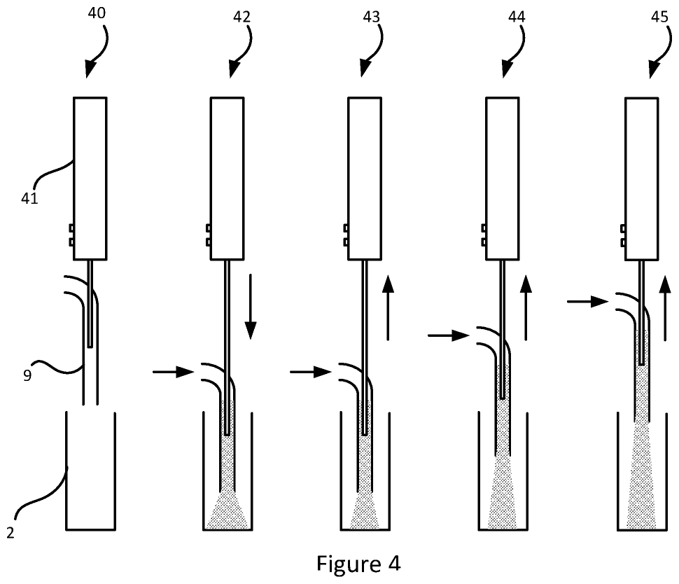

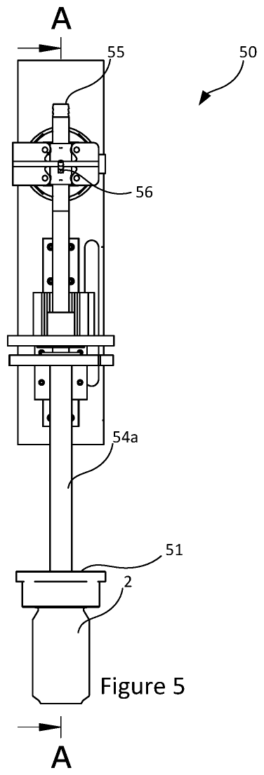

In some embodiments the applicant therefore uses a different method of cleaning the empty can bodies 2 as they enter the system 1. This arrangement is shown in FIG. 1 and in further detail in FIG. 3. Can bodies 2 may enter the system 1 from conveyers, depalletisers, etc to the position shown at 30. A fast-acting pneumatic actuator 3 (or other suitable actuator) may drive 31 a compressed air outlet 32 into the can 2 and jet a high-pressure blast of clean compressed air into the can via outlet 32. Above the can a vacuum cover 4 may pull the compressed air and contaminants from the can body. The actuator 3 then retracts 33.

The can body 2 may then be scanned 34 by any suitable contaminant sensor, or combination of contaminant sensors. In the embodiment shown, a camera 5 may be mounted above the input line. The camera may scan the cans for any contaminants. If any contaminants are sensed, a side acting pneumatic actuator 6 may be actuated to remove the can from the system.

Returning to FIG. 1, the cleaned can bodies may now enter a first pre-fill conveyor 8. In the embodiment of FIG. 1, the conveyor 8 is in the form of a carousel that transports the can bodies 2 to a filler. Further, the pre-fill conveyor may provide for pre-filling processes to be performed. In the embodiment of FIG. 1, each can is transported in a carousel position that incorporates a pre-purge outlet 9. Each pre-purge outlet 9 is arranged to introduce an inert gas (e.g. carbon dioxide) into the can body, reducing the oxygen or air content of the can body before filling. This reduction in latent oxygen levels in the empty cans is believed to allow higher throughput for a given number of filler heads, since the fill process begins with already reduced latent oxygen levels. This effectively extends the filling pre-purge cycle, with further purging performed by the fill head, as described below.

In some embodiments, the pre-purge outlet may be mounted to a suitable actuator and descend into the base of the can for pre-purge, as shown in FIG. 4. At 40 an empty can body 2 is positioned beneath a pre-purge outlet 9. An actuator 41 moves the outlet 9 down into the can body 2, as shown at 42.

Any suitable control/actuation schedule and/or mechanism may be used to switch the flow of gas on/off and set the flow rate. In some embodiments a jet or short burst of high-pressure CO₂ may be introduced into the can at position 42. This burst may ‘delaminate’ oxygen from the inner lining of the can, introduce turbulent flow and force the turbulent air mix out of the can due to pressure differential.

Following the initial burst, CO₂ may be trickled, or introduced at a lower flow rate compared to the burst, into the base of the can. The greater density of the pure CO₂ creates a boundary layer that raises air above the CO₂. As CO₂ trickles into the can, the outlet 9 is raised 43, 44, 45, with the outlet 9 remaining beneath the rising boundary layer of CO₂. Sufficient CO₂ may be introduced to fill the can body 2.

This pre-purge allows longer duration of CO₂ flowing into the can. For example, in one embodiment the pre-purge may allow around 2 to 3, or around 2.25, seconds of CO₂ flow into the can before filling, when processing at 60 cans per minute (cpm).

As shown in FIG. 1, a plurality of pre-purge outlets 9 may be provided.

Further pre-fill processes may be performed while the can is transported on the pre-fill conveyor, or in further pre-fill stations. For example, printing or other marking process may be implemented for applying a batch number/code etc, shelf life, expiry date, other identification markings, unique container ID, or any other desired or legally required information. Any suitable marking system or printer, e.g. a long throw solvent based inkjet printer, Methylethylketone (MEK) based printer, or any suitable laser etcher may be used mark the cans. Printed information may allow linking to stored data for an individual container, batch etc.

In the embodiment shown, the pre-fill conveyor also introduces the can to the canning line, and acts as a buffer-sequentially processing each can into the line from the input conveyor/depalletiser.

The pre-purged can bodies 2 may be passed from the pre-fill conveyor 8 to a fill conveyor 10.

A number of fill heads 11 may be mounted on or near the fill conveyor 10. Each fill head 11 may be arranged to control the environment within the can body 2 and to introduce the beverage into the can body 2. The fill head 11 will be described in detail below.

The filled can bodies 2 are then transported to a closure conveyor 12. While the can is carried by the closure conveyor, a can closure (e.g. can end or lid) is applied. A bulk closure holder 13 may supply closures. The closure station and bulk closure holder will be described in detail below.

The cans 2 with applied closures may then be transported to a sealing conveyor 14. For cans, the sealing conveyor may include a number of seaming stations to seal the closures to the can bodies. The filled and sealed cans then exit the system at F. The sealing station will also be described in detail below.

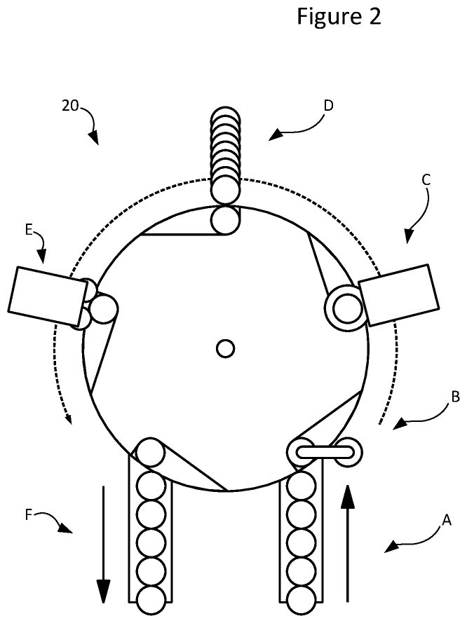

FIG. 2 illustrates a further embodiment, suitable for smaller scale operations, in which the above functions are arranged in a single conveyor or carousel 20. The system may also provide for entry A, pre-fill B, fill C, closure D, sealing E and exit F of containers.

Turning to the fill mechanism, in some embodiments the Applicant's filler is a counter-pressure type filler that varies pressure in the can headspace to control the flowrate of the beverage into the can.

Counter pressure canning systems allow higher flow rates (leading to faster processing speeds), the ability to process carbonated drinks at higher than typical temperatures and/or pressures, and—potentially—greater control of the can's atmospheric oxygen levels.

Counter pressure systems traditionally purge the can with CO₂ and then flow the beverage from a center spigot to the edge of the can interior running the beverage down the can wall to the bottom. This allows for quick action in large commercial rotary head systems. However, this arrangement also exposes the entire surface area of the beverage to the atmosphere in the can. The Applicant believes this results in dissolved oxygen pickup and relies on minimal oxygen remaining in the can.

Unlike traditional counter pressure fillers, the Applicant's fill tube descends to the bottom of the can, introduces CO₂ to the base of the can and then flows the beverage to the base of the can.

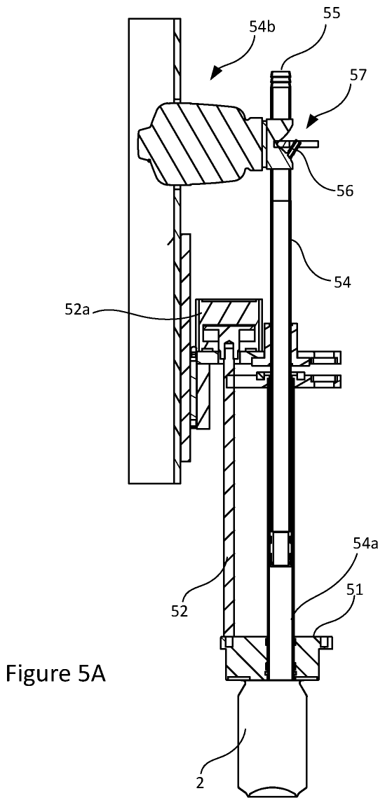

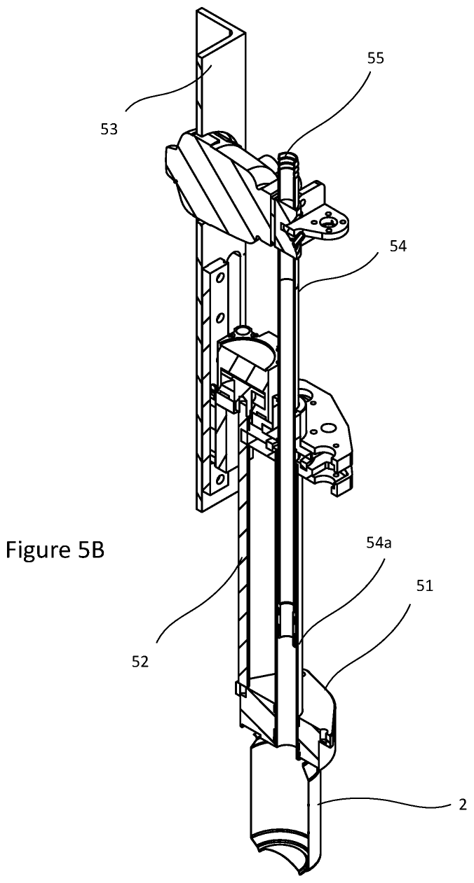

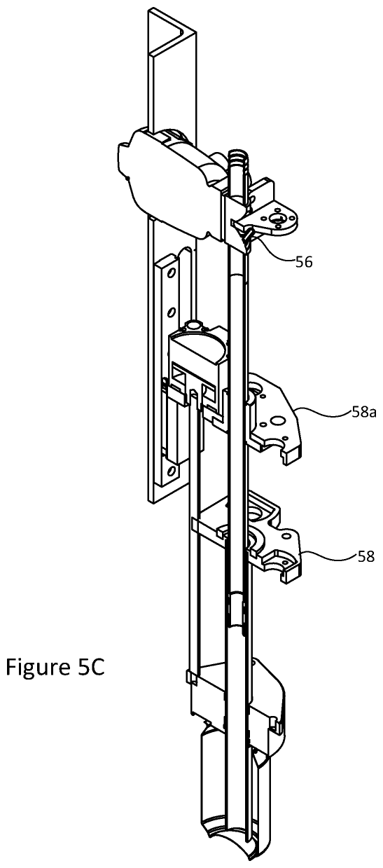

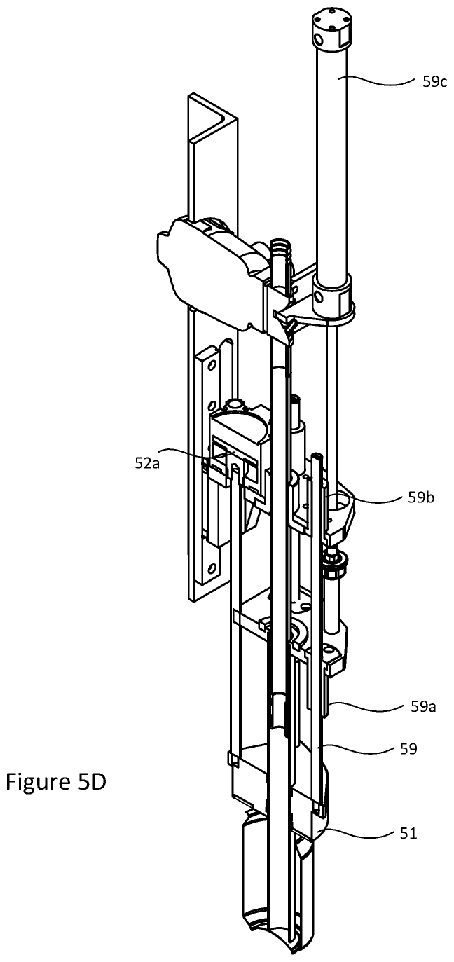

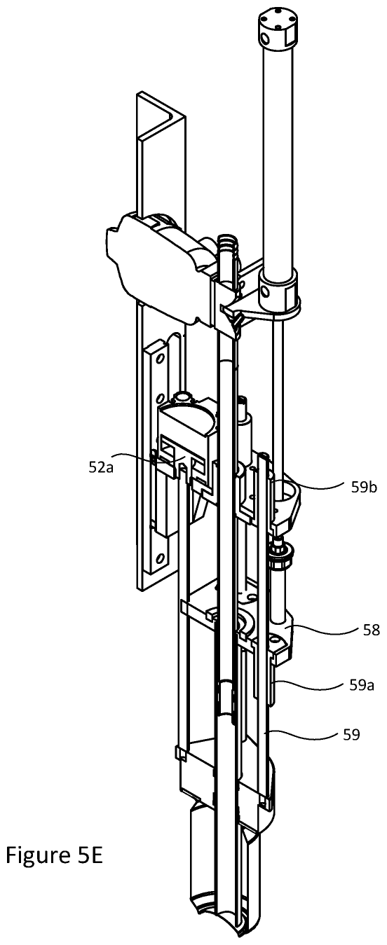

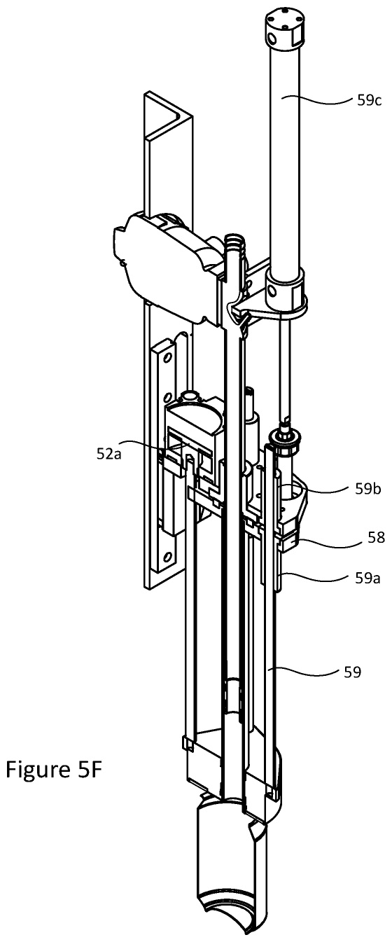

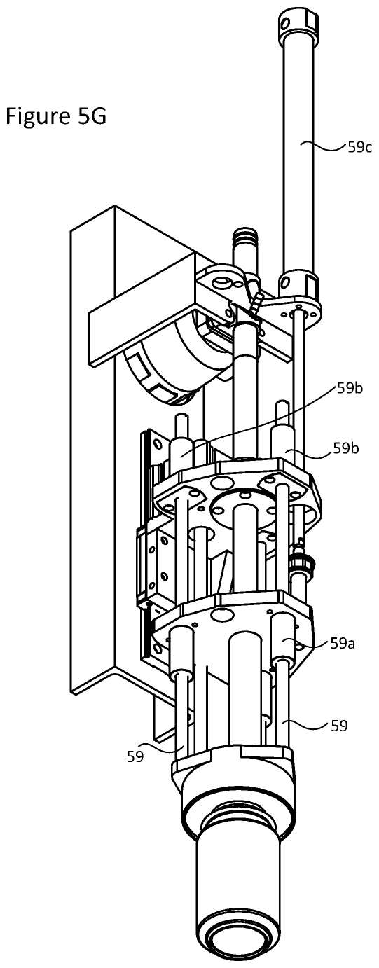

FIGS. 5 to 5G show a fill head 50 according to one embodiment. The fill head includes a fill head closure 51 adapted to be lowered onto the rim of the can body 2 to provide a closed or sealed environment within the can body 2. The fill head closure 51 may be mounted by one or more shafts 52. The carriage may be driven by an actuator 52a acting on shaft 52 to raise and lower the filler head closure 51. The filler head closure may have a seal, such as a silicon seal, configured to seal against the rim of the can body 2.

In the embodiment shown, a fill conduit is formed in two sections 54, 54a. The upper section 54 is mounted to an upper support 54b that is attached to a rail or other structure 53. The lower section 54a slides relative to the upper section 54, forming a ‘telescoping’ fill conduit that can be extended into the can body and retracted from the can body, as will become clear below. The lower fill conduit section 54a is also configured to slide through the fill head closure 51. The position of the fill conduit outlet (i.e. at its bottom end) may therefore be adjusted independently of the fill head closure. A suitable arrangement of seals may be provided to seal the sliding interfaces between the upper and lower fill conduit sections 54, 54a and between the lower fill conduit section 54a and the fill conduit closure 51.

At its other end the fill conduit may be connected to both a beverage inlet 55 and a CO₂ inlet 56. A beverage or fill valve 57 may be provided between the beverage inlet and CO₂ inlet, controlling the flow of beverage into the fill conduit. This beverage valve may operate essentially as an ‘on/off’ valve, with flow rate controlled by the vent valve, as described below. A separate CO₂ valve (not shown in FIGS. 5A-5C) controls flow of CO₂ to the CO₂ inlet. This arrangement provides for the supply of both beverage and CO₂ through the same fill conduit, or a single fill conduit, into the can body 2.

FIG. 5C shows how the fill conduit may be extended into the can body 2. This extension may be driven by driving relative motion of bracket 58 relative to bracket 58a.

FIGS. 5D-5F show three positions of the filling system of FIG. 5G. As shown in these drawings, the fill head closure 51 may be further supported by a number of shafts 59 attached to the head closure 51 and riding in bushings or linear bearings 59a, 59b.

FIG. 5D shows the fill head above the can 2. The fill conduit 54a has been extended to a region near the bottom of the can body 2. In FIG. 5E, actuator 52a has acted on shaft 52 to move the fill head 51 down onto the can body 2, sealing against the can rim. This movement is independent of the sliding movement of the fill conduit 54a, which has not moved from the position of FIG. 5D. In FIG. 5E, the fill conduit has been withdrawn, by actuator 59c acting on bracket 58. The fill head has been raised by actuator 52a, which has returned to the position of FIG. 5D.

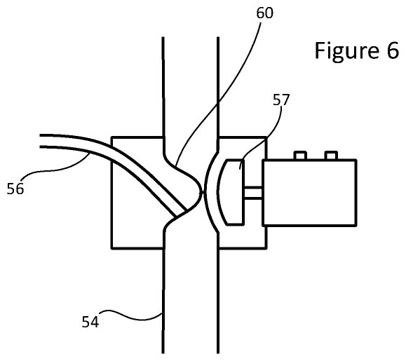

FIG. 6 is an expanded cross-section of the fill conduit 54 and flow valve 57. In this embodiment, the flow conduit passes a flow restriction or weir 60, with a diaphragm valve 57 acting against the weir 60 to close the flow of beverage into the lower part of the fill conduit 54. The diaphragm valve may be ‘normally closed’. While other valves may be used, the diaphragm valve has low ‘dead space’, resulting in good hygiene, and provides the ability to process pulps and sediment without fouling the valve. The CO₂ inlet 56 connects into the fill conduit below the weir 60 and valve 57.

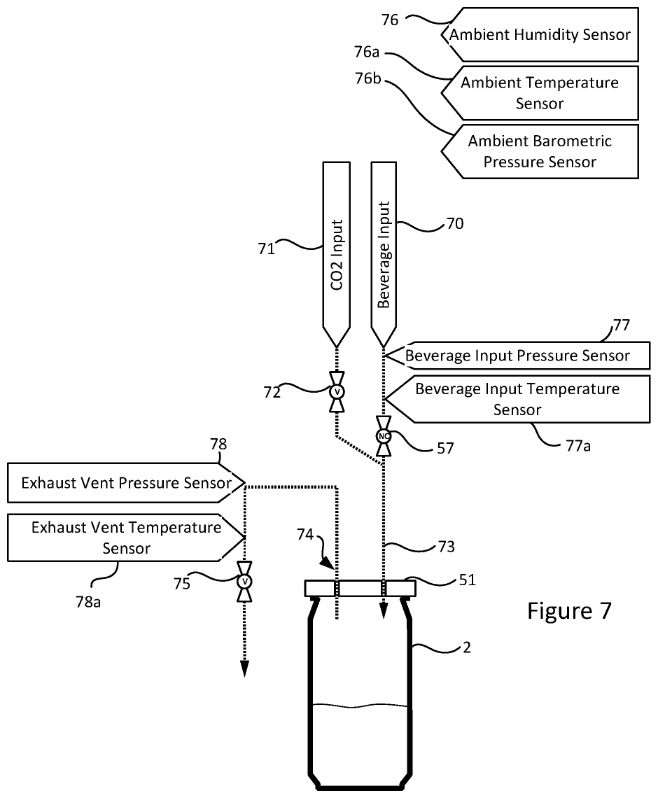

FIG. 7 is a flow diagram, illustrating the valves and flow of CO₂ and beverage in the fill head of FIGS. 5-6. Mechanical features are excluded from this drawing for clarity. Flow of beverage from a beverage source 70 is controlled by the beverage valve 57. The beverage source may be a pressurised beverage source. The beverage valve 57 may be a normally closed diaphragm valve, or any other suitable valve. Flow of CO₂ from a CO₂ source 71 is controlled by a controllable variable CO₂ valve 72. Both beverage and CO₂ flow 73 into the can 2 through the same fill conduit. An exhaust or vent outlet 74 allows venting of the can interior, controlled by a controllable variable exhaust or vent valve 75.

The fill process may be controlled based on data from a number of sensors. Ambient conditions may be measured, for example by humidity 76, temperature 76a and barometric pressure 76b sensors. Beverage input parameters may be measured, for example by beverage input pressure 77 and temperature 77a sensors. Exhaust parameters may be measured, for example by exhaust pressure 78 and temperature 78a sensors. Flow may be controlled by the vent valve, based on a differential pressure between inlet/exhaust sensors.

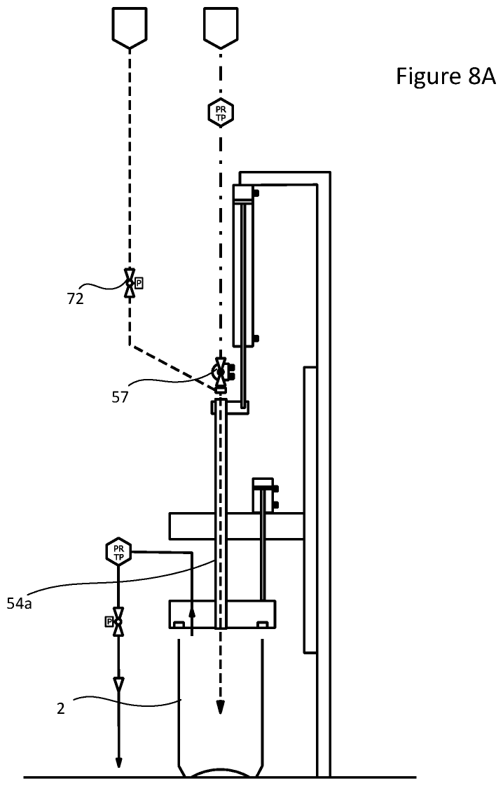

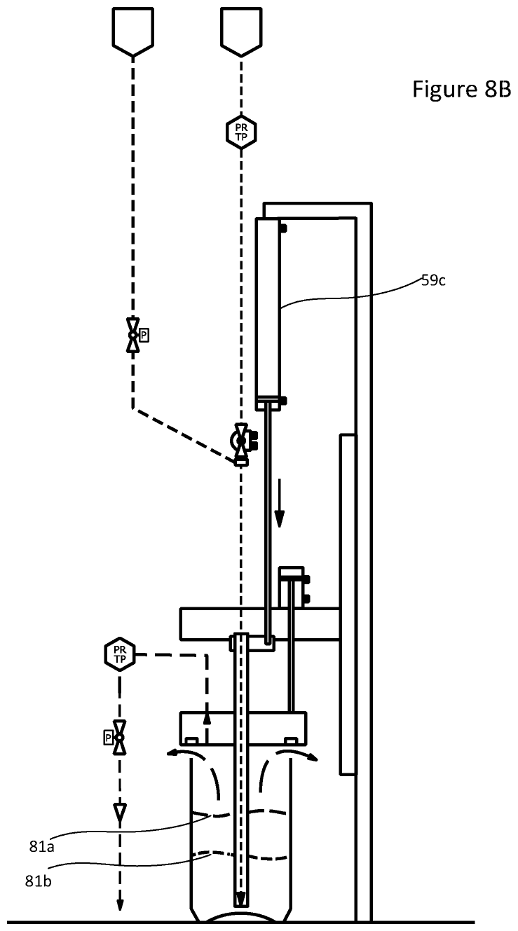

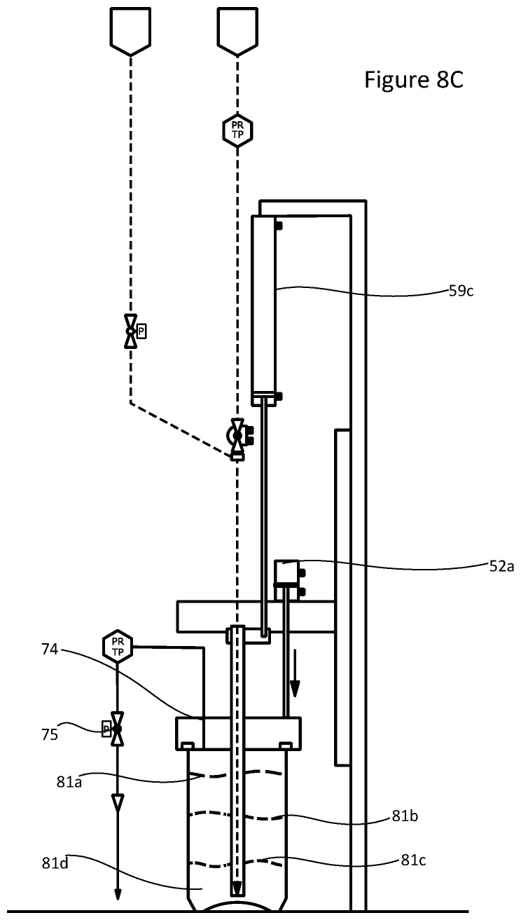

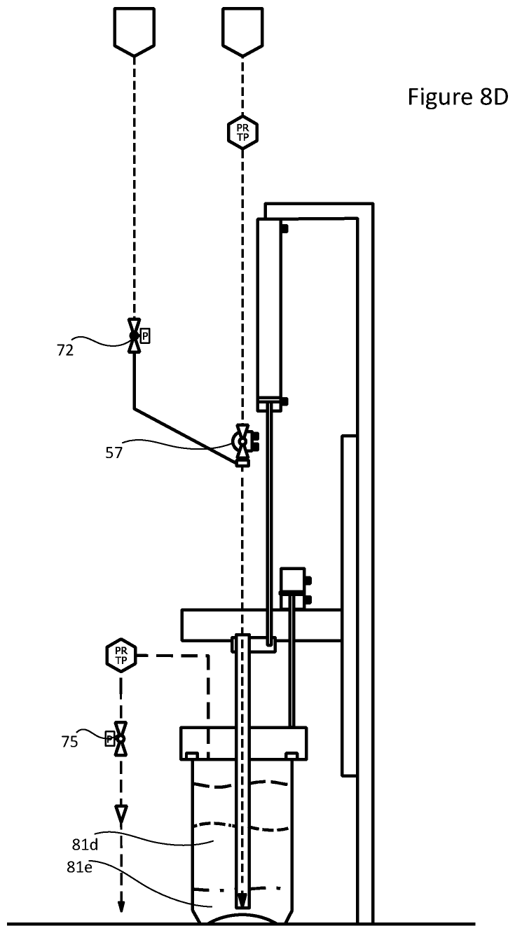

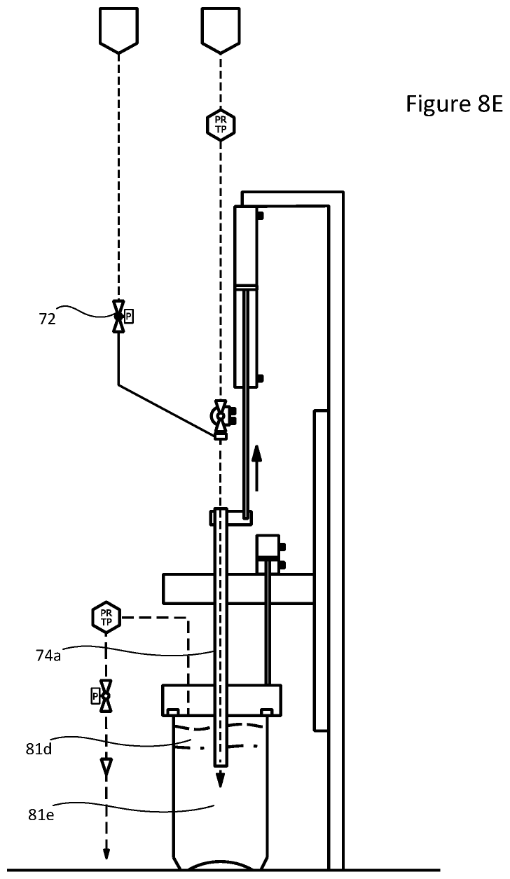

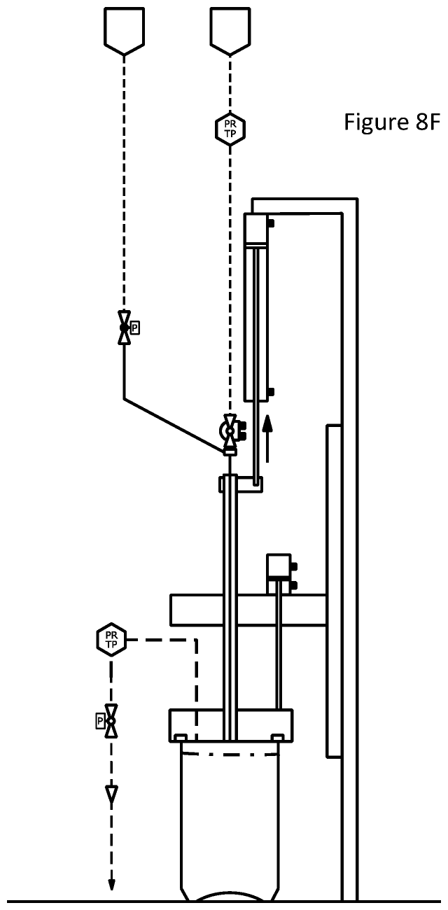

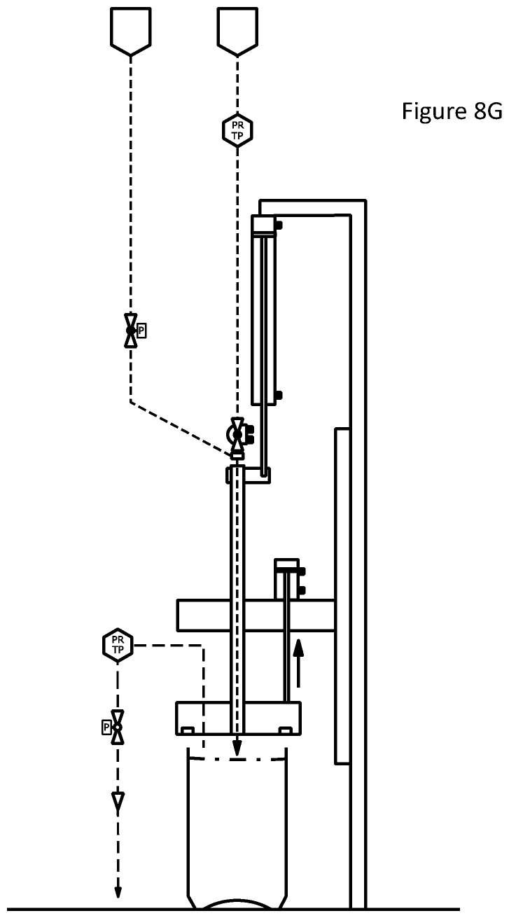

FIGS. 8A to 8G illustrate one embodiment of fill process using the fill head of FIGS. 5-6.

In FIG. 8A, a can body 2 is brought into position beneath the fill head. In this position, the beverage valve 57 is closed. The CO₂ inlet valve 72 may be controlled to provide a low-level flow through the fill conduit. This prevents (lighter than CO₂) oxygen from ascending into the fill conduit 54a. The CO₂ flow may be increased to purge any residual oxygen.

In FIG. 8B, the flow conduit is extended down into the can body 2, by actuator 59c. The extent of required movement may depend on the container size, type etc. The flow of CO₂ into the can is increased. CO₂ fills the can body and begins to escape between the can rim and the fill head closure 51. In general, the concentration of (heavier than air) CO₂ may be greater at the bottom of the can, as indicated by dashed lines 81a, 81b, 81c.

In FIG. 8C, the fill head closure is lowered by actuator 52a and seals against the rim of the can body 2. The pressure in the can rises. Flow of gas out of the vent port 74, and the pressure in the can, is controlled by the vent valve 75. Maximum flow of CO₂ is provided into the can body. A dense boundary layer 81d of CO₂ may form in the base of the can 2.

In FIG. 8D, the CO₂ valve 72 is closed. In some embodiments the valve may be left slightly open to maintain pressure downstream of the CO₂ valve 72. This may help to prevent flow of beverage up the CO₂ line towards the CO₂ valve. The beverage valve 52 is opened. Beverage flows down the fill conduit to the base of the can, forming a layer of liquid 81e beneath the dense boundary layer of CO2 81d. Pressure within the can, and flow of beverage into the can, is controlled by the vent valve 75.

In FIG. 8E the beverage layer 81e continues to fill the can. The fill conduit 74a may be raised as the can is filled, though as shown its outlet preferably remains below the surface level of liquid in the can.

Flow may begin slowly before increasing to a maximum flow rate.

In FIG. 8F the can has been filled. In general, the filling process may be based on a controlled flow profile over a set time period. In that case, it is not necessary to sense a ‘full’ condition of the can. Subsequently, e.g. at the lidder, or elsewhere in the system, can weight may be measured as a quality control check.

The beverage valve 57 is closed. The flow conduit 54a has been raised. The can is still pressurised. The CO₂ valve may be controlled to equalise pressure between the fill conduit 54a and the headspace within the can 2. The flow of CO₂ may then be reduced or switched off completely, with the vent valve 75 snifting. During snifting, the vent valve slowly releases pressure until the pressure inside the can is equal with atmospheric pressure. The slow release of pressure helps control foaming as CO₂ breaks out of solution.

A good snift seeks to create a CO₂ based foam head that protects the beverage from ambient oxygen. The foam head should last until the application of the can end to the open can. At that time, the top layer of foam, which will have absorbed oxygen, is removed and the can-end applied. Too much foam results in waste and/or underweight fills. Too little foam does not allow the bubble breaker (described below) to remove the top layer of foam with its absorbed oxygen. The snift is therefore important in determining the total dissolved oxygen of the final can. In FIG. 8G the fill head closure 51 is raised. The CO₂ valve provides low level flow to the top of the open can. The fill process is complete and the can is moved on from beneath the fill head. Optionally a blast of CO₂ may be provided to clear any residual liquid from the fill tube before the next can is positioned beneath the fill head.

Note that beverage is not exposed to atmosphere within the fill apparatus. Beverage from the source is contained above the beverage valve, which is opened only when an inert atmosphere has been established in the container. The beverage valve is closed before the fill head is lifted from the container. Further, beverage in the container after filling may be protected by the flow of inert gas over the container and (in brewed beverages) by the formation and later removal of foam.

In some embodiments, the fill process may be capable of processing around 6 to 12 cpm per fill head.

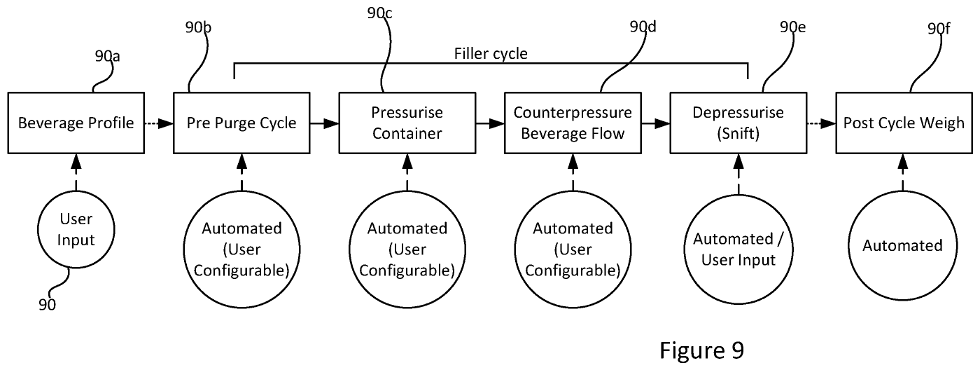

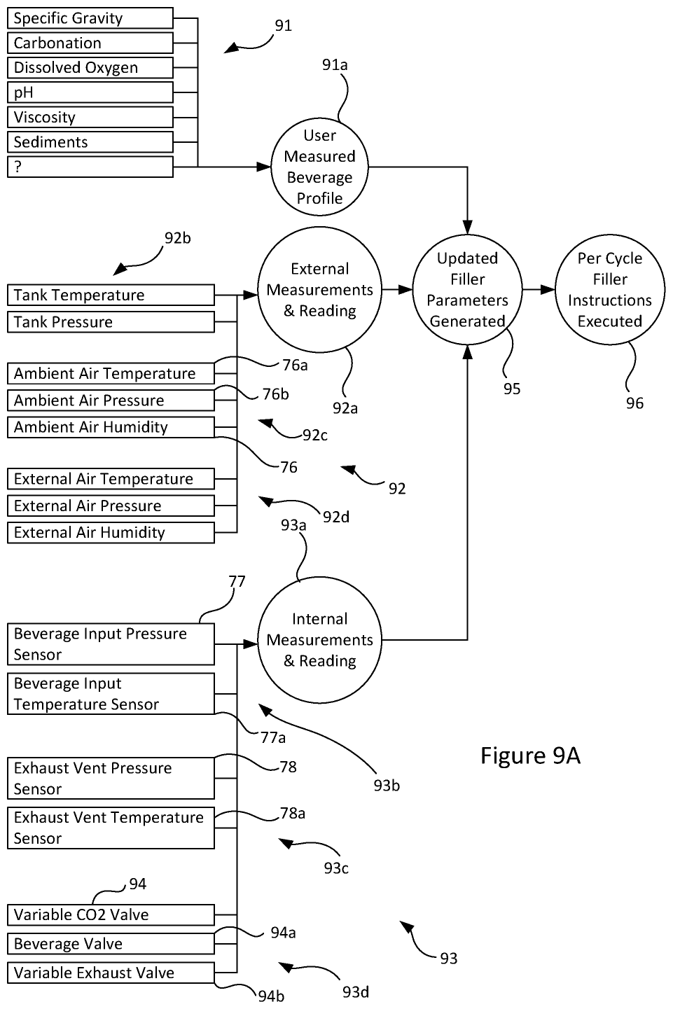

FIG. 9 illustrates one embodiment of how the fill process may be controlled. At 90 a user inputs a beverage profile 90a (e.g. a profile of one or more of: beverage type, specific gravity, alcohol by volume (ABV) %, carbonation, dissolved oxygen, pH, viscosity, sediments etc). The controller then drives the fill head through the above fill process, including purge 90b, pressurising 90c, counterpressure filling 90d and depressurising 90e. Any of these steps may be wholly automated. In some embodiments, user configuration of the purge, pressurising and filling stages may be allowed. Some user configuration or control of the depressurising stage may also be allowed.

After filling, the container may be weighed 90f to check that the can is filled to a correct volume, within allowable limits. In an automated system, the measured weights may be used to train the PID loop for correct pour volume accounting for differing parameters, such as pressures and temperatures.

FIG. 9A shows a further embodiment of control arrangement for a beverage filling system. A user may input a number of beverage characteristics 91, including for example any one or more of: beverage type, specific gravity, carbonisation, dissolved oxygen, pH, viscosity, sediment level and any other desired characteristics. These beverage characteristics may be stored in a beverage profile 91a. In alternative systems some of these characteristics may be measured rather than user-input.

One or more external sensors 92 (that is, sensors external to the fill system) provide external measurements or readings 92a. These sensors may include any one or more of: beverage tank sensors 92b, including sensors of tank pressure, temperature etc; one or more ambient condition sensors 92c, including e.g. sensors of ambient humidity 76, temperature 76a, pressure 76b etc; and/or one or more external condition (e.g. weather) sensors 92d including e,g, sensors of external pressure, temperature, humidity etc. External condition data may be obtained from public sources, e.g. over the Internet. Any other desired sensors may be used.

Further, a number of internal sensors 93 (that is, sensors forming part of the filling system) provide internal measurements or readings 93a. These may include one or more beverage input sensors 93b, including e.g. sensors of any one or more of beverage pressure 77, temperature 77a etc; one or more exhaust or vent sensors 93c, including e.g. sensors of any one or more of vent pressure 78 and vent temperature 78a; and one or more valve state or position sensors 93d, including e.g. CO₂ inlet valve sensor 94, beverage valve sensor 94a and vent valve sensor 94b. Any other desired sensors may be used.

Based on the beverage profile 91a, external sensor data 92a and internal sensor data 93a, the fill process may be controlled. In one embodiment, fill parameters may be updated 95 and each fill cycle controlled accordingly 96.

In general, the venting of the can by the vent or exhaust valve 75 may be controlled by any suitable arrangement, including e.g. by proportional control in a closed Proportional Integral Derivative (PID) loop. Pressure and temperature sensors are mounted upstream of the vent valve 75 to ensure an accurate real time measurement to control the PID loop and therefore the proportional vent control. These sensors may have fine or ultra-fine resolution.

The individual fill heads may be controlled by pneumatic actuators for reliability, repeatability and speed. Each fill head may be independent, providing individual control of each fill, as well as quick replacement in the field.

The Applicant's fill arrangement and process provide reduced exposure of beverage to the can atmosphere when compared to conventional counterpressure systems. Beverage turbulence is reduced and control of CO₂ within the can reduces oxygen pickup.

The Applicant's fill arrangement and process provide greater control of the can atmosphere and pour/fill characteristics compared to traditional open pour systems.

The Applicant's filling system therefore provides improvements over both conventional open pour and conventional counter pressure systems.

In some embodiments, the Applicant's filler station or filler carousel is near to, or directly coupled to, the subsequent lidder and seamer stations. This creates a consistent short duration of exposure of the beverage in the can to atmosphere, between filling and sealing. Further, this time between filling and sealing may be constant or at least relatively uniform, allowing the system and/or the operator to adjust for an improved or optimum snift that is uniform for all cans.

This can be contrasted with many conventional systems, including most low volume canning lines, which use conveyors with significant space and delay between operations. In conventional systems, numbers of cans are often collected or buffered at various phases in the canning process.

The filled can is now passed to a closure system. In this embodiment, the closure system acts to apply a closure to the container, but does not act to seal the closure to the container. Instead, sealing is performed in a subsequent operation described below. However, in some applications closure application and sealing may be performed in a single station.

In general, closures may be supplied in bulk sleeves. For example, standard CDL 202 can ends may be supplied in standard sleeves of 552 can ends.

In some conventional systems, a simple lidder uses a mechanical element that ‘catches’ on a moving can-end, pushing it onto a can. However, in high-speed machines this ‘catch lidder’ mechanism experiences high failure rates and can cause damage to the edge of the can lid, resulting in poor quality sealing and faulty product on retailer's shelves. In contrast, the Applicant's closure system positions the can-end directly above a filled can and pushes the can-end down vertically whilst under gassing with CO₂ the entire duration. This reduces or eliminates damage to the can or can-end.

Further, in conventional lidders, operators must manually fill the lid mechanism, often one sleeve at a time. At 40 cans per minute (cpm), a standard sleeve of 552 can-ends will be finished in under 14 mins, requiring the operator to fill the lidder repeatedly. The Applicant's closure system uses a bulk closure store or holder to house multiple sleeves of closures. For example, in one embodiment a rotary closure holder may house six full can-end sleeves that can be filled at one time. At the above usage rate, six 552 can-end sleeves will need to be refilled every 1 hour 22 minutes, reducing operator intervention and associated labour costs.

In use, detachable can-end sleeve holders may be removed from the rotary lidder mechanism, filled with one sleeve each and reconnected. Alternatively, sleeve holders may be filled without removal from the machine.

The Applicant's lidder mechanism may be adjustable for a number of commonly available can-end sizes and profiles (generally ‘types’), including e.g. B64 200, 202, 206, 209, CDL 200, 202, 206, 209, Superend 200, 202, 206, 209. Further, the Applicant's systems may be adjustable or capable of processing a variety of can heights, including e.g. can heights from 88.5 mm (150 ml Slim Can) to 204.8 (1000 ml King Can).

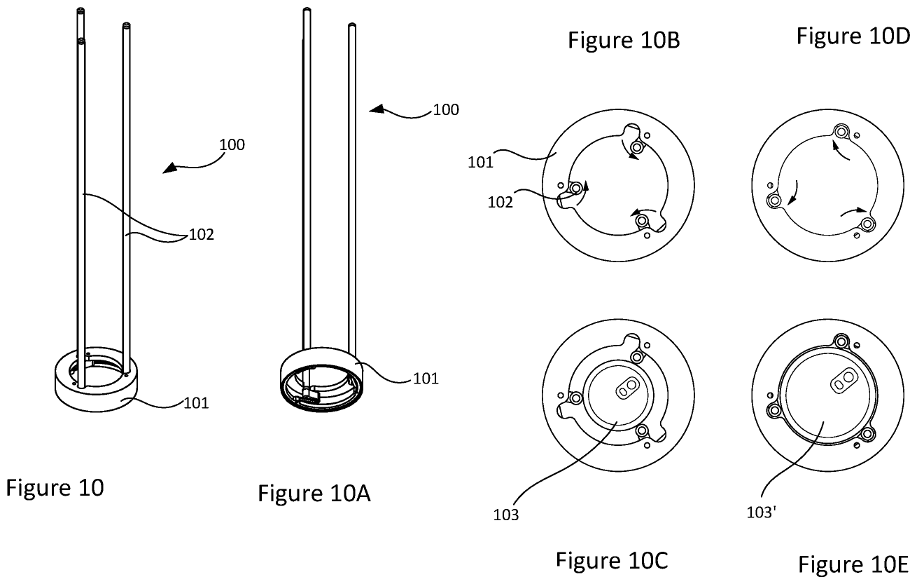

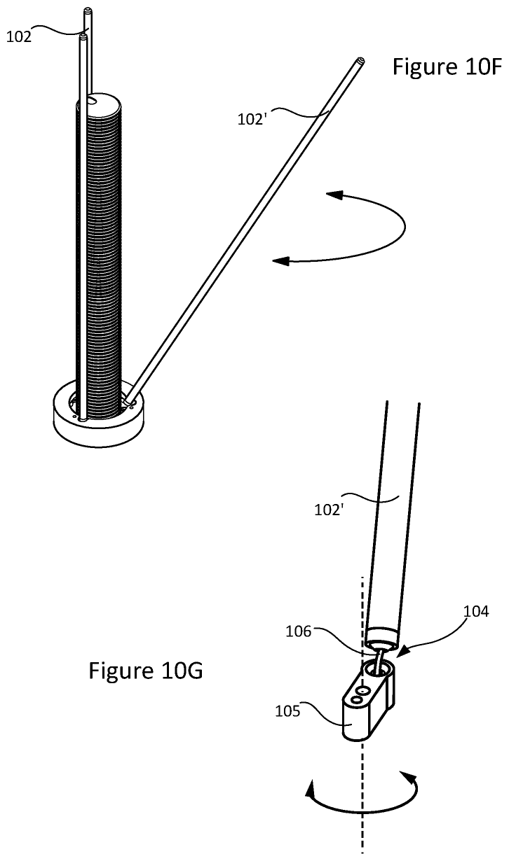

FIGS. 10 to 10E illustrate a closure holder 100. The closure holder may include a base 101 with a number of upwardly extending retainers 102. In the embodiment shown three retainers are provided. Such a closure holder could be designed for a particular size of closure. A number of differently sized closure holders may be provided for different sizes of closure. However, in some embodiments the Applicant's closure holder is adjustable for different closure sizes. A shown in FIGS. 10B and 10D, the positions of the retainers 102 may be adjusted. FIG. 10C shows the closure holder holding a smaller can end 103 and FIG. 10E shows the closure holder holding a larger can end 103′. This may either be adjusted manually or automatically across one or all of the bulk closure holders.

FIG. 10F shows how one or more (preferably one) of the retainers 102′ may be movable in order to allow refilling of the closure holder from the side. This may be done using any suitable hinge or similar mechanism. In one embodiment, shown in FIG. 10G, the retainer 102′ may engage in a socket 104 in a fixed retainer base 105. The retainer 102′ is biased to the upright position by a section of bungee cord 106, or other elastic or spring element.

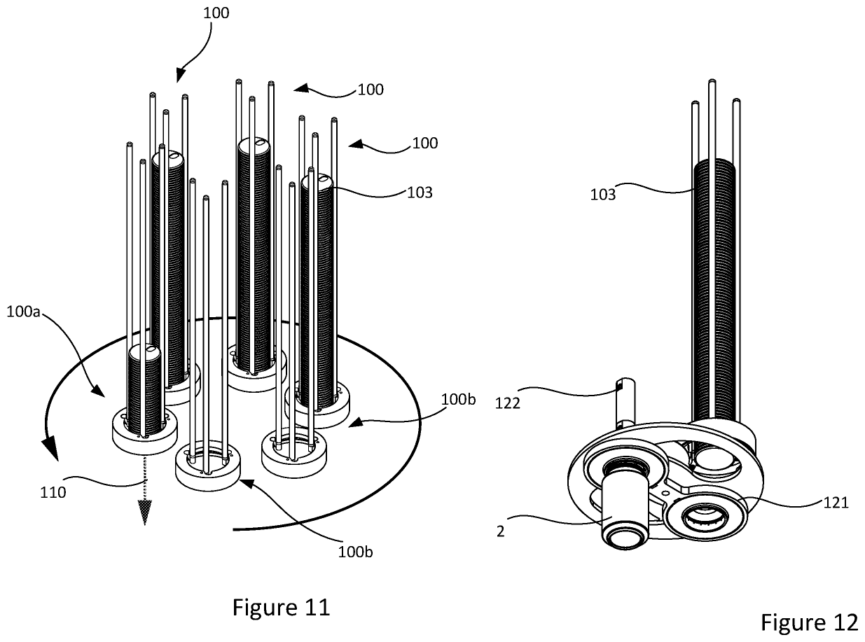

FIG. 11 shows six closure holders or magazines 100 arranged in a rotary bulk closure holder. Closure holders 100 are filled with can ends 103. Closure holder 100a is positioned above the lidder system and can ends are passing from that closure holder 100a as indicated by arrow 110. Closure holders 100b have emptied their can ends in the position now occupied by closure holder 100a, and are ready to be refilled.

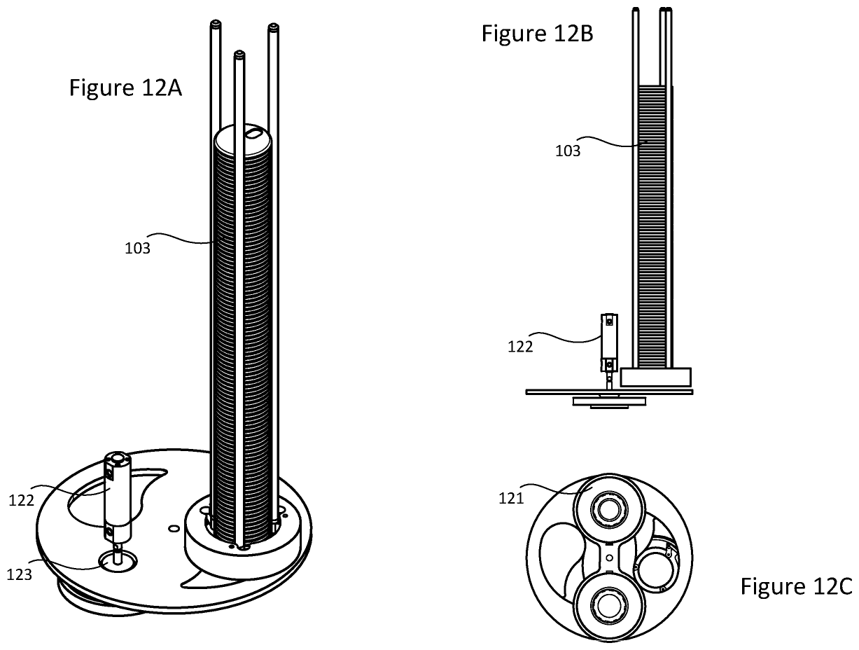

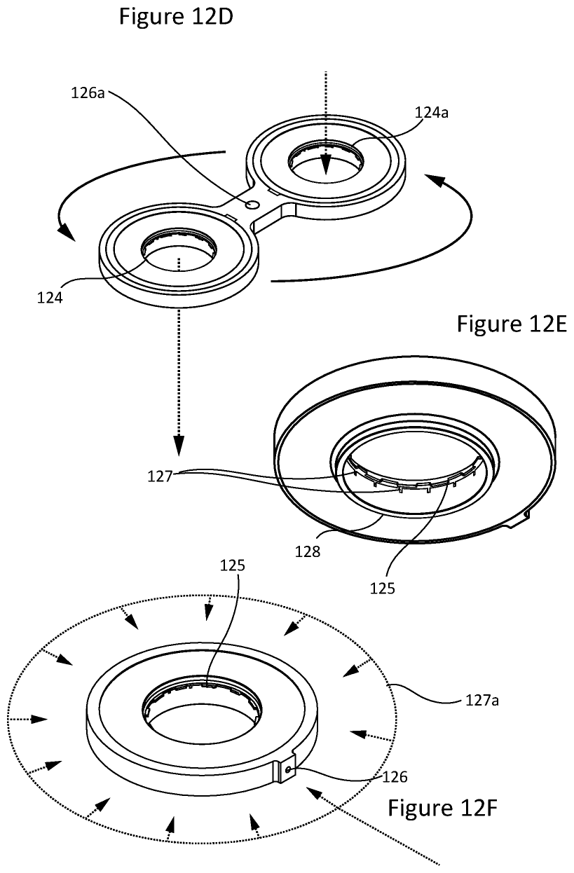

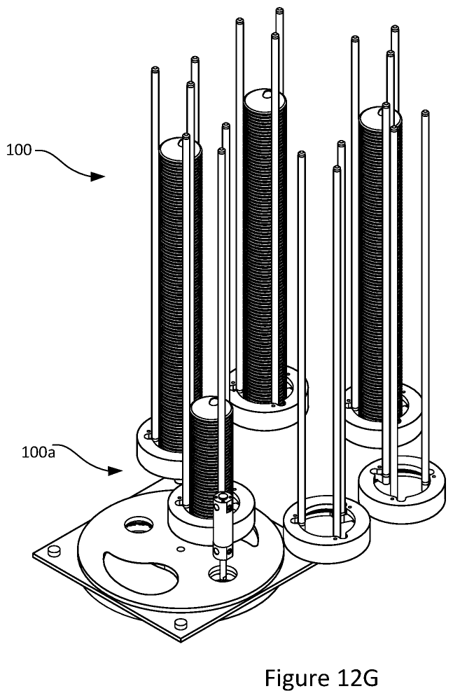

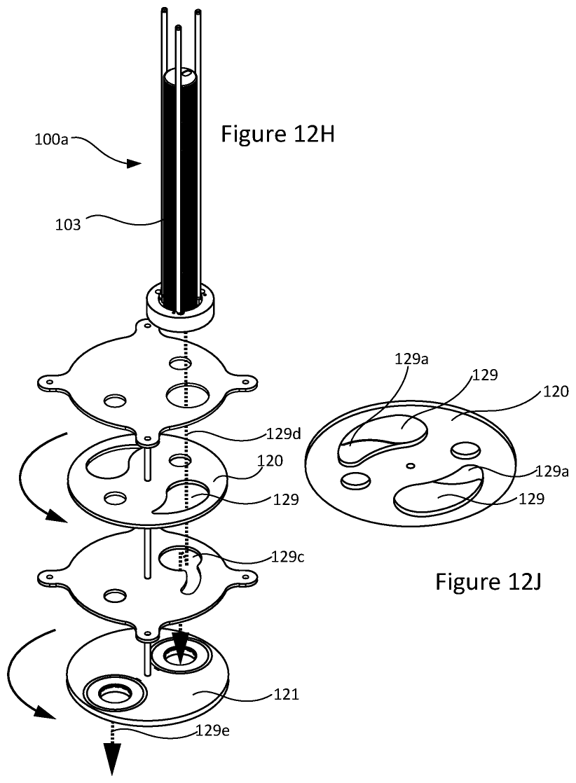

FIGS. 12-12J illustrate a further stage of the closure system. An intermediate closure holder 120 holds a number of closures. These are received from the bulk closure holder, in particular from the closure holder 100a (arrow 110 in FIG. 11, and the arrangement is also shown in FIG. 12G). These closures 103 are fed to a closure head 121, which is arranged to move closures from the intermediate closure holder 120 to a position above a can 2. In this position an actuator 122 drives a pusher 123 to push a can-end down onto the can 2.

FIGS. 12H and 12J show the intermediate closure holder 120 in more detail. In general, the intermediate closure holder may hold one or more closures. Here the intermediate closure holder 120 includes two closure bearers 129, each arranged to receive a closure from closure holder 100a and to carry that closure to a position where it is free to drop down onto the closure head 121 (here shown as a circular plate rather than the ‘dog-bone’ shape of FIGS. 12 to 12G). As shown in the bottom view of FIG. 12J, each closure bearer 129 may include a cut-out section with a thinned ‘slicer’ or closure separator 129a. This separator acts to separate the lowest closure 103 from the stack of closures in holder 100a. The separated closure is then held in the cut-out 129, and carried with rotation of the intermediate closure holder 120 until it passes over a hole 129c, allowing it to drop down onto the closure head 121. In this embodiment, a closure generally follows the path marked by dashed line 129d, is retained by the closure head for half a turn and then applied 129e to a can.

FIGS. 12D-12 F show the closure head 121 in more detail. As shown in FIG. 12D, the closure head may include two or more closure positions 124, 124a, each configured to receive a closure from the intermediate closure holder 120 and transport it to a position under the pusher 123 and above the can 2. Each can position 124 may include a number of resilient, flexible tabs, protrusions or other features 125. These are able to retain a closure, but flex out of the path of the closure when it is pushed by pusher 123 down onto the can. These features 125 may be formed as a single piece, and may be replaceable for different can end sizes or types.

Further, each closure position 124 may be equipped with a CO₂ inlet 126 that communicates with a central CO₂ inlet 126a at the pivot point of the closure head 121. CO₂ may pass from these inlets to a number of CO₂ outlets or vents 127 positioned around the circumference of the closure position 124. These vents may be beneath they tabs 125, such that CO₂ is introduced into the space between the closure and the can (an ‘underlid’ CO₂ flow). This underlid flow may be directed inwards from the outlets 127, distributed around the periphery of the closure position 124, as indicated by dashed arrows 127a in FIG. 12F. The closure head may be mounted on a suitable hollow shaft, allowing rotation of the closure head about its pivot point and supply of CO₂ through the hollow shaft to inlet 126a.

The closure head may include a number of skirts 128 (also known as bubble breakers) arranged to skim across the top of the can as the rotating closure head moves into position. This tends to wipe away the surface foam, including any oxygen that has been absorbed into the foam surface since the can was filled. This arrangement therefore further reduces the opportunity for oxygen to be captured.

In a further embodiment, an inert gas (e.g. nitrogen) doser may be arranged before the closure head, in order to introduce inert gas to the top of the can before a closure is applied. This is particularly applicable to packaging of still beverages, for example.

In one embodiment of the closure system, operation may be as follows. A user may install can-end sleeves into the detachable can-end sleeve holders-adjusting the palls for any specific can-end diameter. The user may install the fully loaded sleeve holders into the bulk closure holder. The system automatically feeds and positions filled cans to a position under the closure head. The closure head moves into position, a skirt wiping foam from the top of the can. CO₂ flows across the open can under the can-end that sits on tabs above the open can. The pneumatic closure pusher forces the can end onto the open can. The can and can-end are now moved on from the closure system to a sealer or seamer as described below.

A new can is fed into position and the closure holder rotates through 180 degrees, bringing a further can-end into position.

The above system provides for application of a closure without mechanical action against the lip of the closure (as in e.g. convention flip-lidders). Instead, the can-end is supported by resilient elements and is then pushed directly downwards by a pusher that operates on the center of the can-end rather than its lip.

The combined can body 2 and can-end 103 now pass to the seamer, which forms a seam between the two, forming a complete sealed can.

The seamer attaches the can end (lid) to the pre-filled can. In general, seamers are high precision machines, capable of repeatable and accurate positioning of the seamer rollers for thousands of cycles. Conventional machines are difficult to adjust and seamer engineers are employed to ensure consistent calibration. In contrast, the Applicant's seamer provides accurate and consistent seaming without the need for expert calibration or supervision.

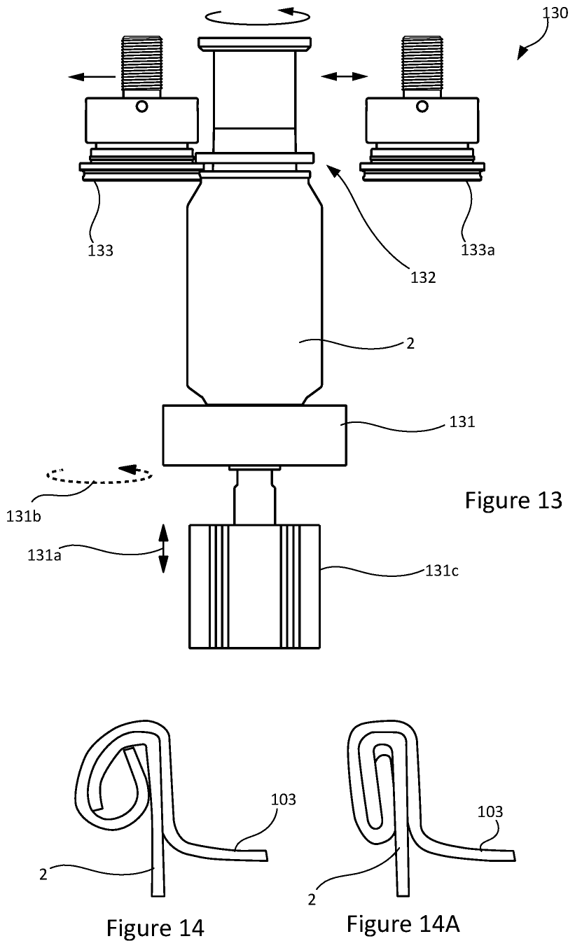

FIG. 13 shows a can body 2 (with a can-end in position but not visible in this view), positioned beneath the seamer 130. In general, some mechanism for aligning the vertical positions of the can and seamer may be needed. As discussed below, some embodiments use conveying mechanisms that accurately position the cans. In the embodiment shown, a can support 131 moves vertically 131a to bring a can upwards into the correct vertical position relative to the seamer 130. The can support 131 is also arranged to spin 131b, such that it moves with the rotational motion of the can. Vertical motion of the can support may be driven by any suitable actuator 131c. The spinning motion may be driven or passive, with primary drive of the can rotation provided by the seaming chuck, as will become clear below. In some embodiments the seaming chuck may be constantly spinning (e.g. at around 400 rpm) with cans simply brought into and out of contact with the constantly spinning chuck.

The can support may be driven by any suitable actuator 131c, e.g. a pneumatic actuator, to apply consistent upwards force or pressure onto the base of the can. In one embodiment the upwards force may be around 500N.

The skilled reader will understand that other manners of providing the required relative motion between can and seamer are possible. For example, the seamer may be movable relative to a stationary can.

In general, the seamer 130 includes a seaming chuck 132 and one or more seaming rollers 133, 133a. In the embodiment shown, two seaming rollers are provided, allowing the formation of a seam in two stages (so called double seaming). However, any desired number and combination of seaming rollers may be provided. Double seaming is illustrated in FIGS. 14 and 14A, where a seam is formed between a can body 2 and a can-end 103 by a seaming operation consisting of a first stage (FIG. 14, by the combined action of the seaming chuck 132 and a first seaming roller 133) and a second stage (FIG. 14A, by the combined action of the seaming chuck 132 and a second seaming roller 133a).

The seaming chuck acts against the can-end 103, pressing the can-end into position on the can body 2. The seaming chuck also spins, driving rotational motion of the can body 2 and can-end 103 relative to the seaming rollers 133, 133a. Further, the profile of the seaming chuck may be such as to support and/or form the inside of the seam.

Each seaming roller 133, 133a has a profile that is arranged to deform the rim of the can body and/or the can end to form the resulting seam. The seaming rollers may each have a range of motion from a disengaged position (e.g. the position of roller 133a in FIG. 13) through to a fully engaged or end position (e.g. the position of roller 133 in FIG. 13). In the end position, the deformation of the seam by that seaming roller is complete. Thus, for example, the system may drive a first roller 133 through its full range of motion in a first seaming stage, resulting in the partially formed seam of FIG. 14. The system may then drive a second roller 133a through its full range of motion to form the completed seam of FIG. 14A. In general, each roller may dwell in its end-position after moving through its full range of motion. For example, each roller may dwell for around 1.25 rotations of the can after reaching its end position.

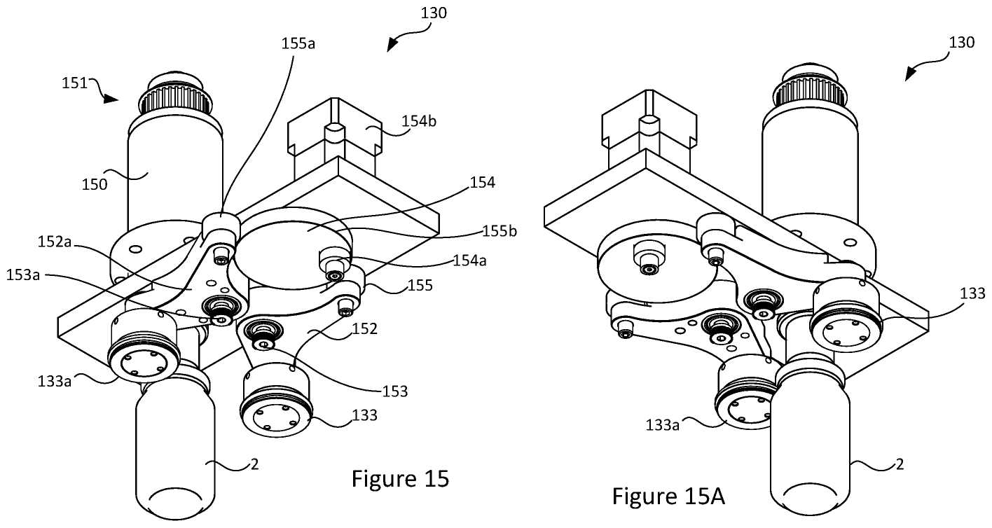

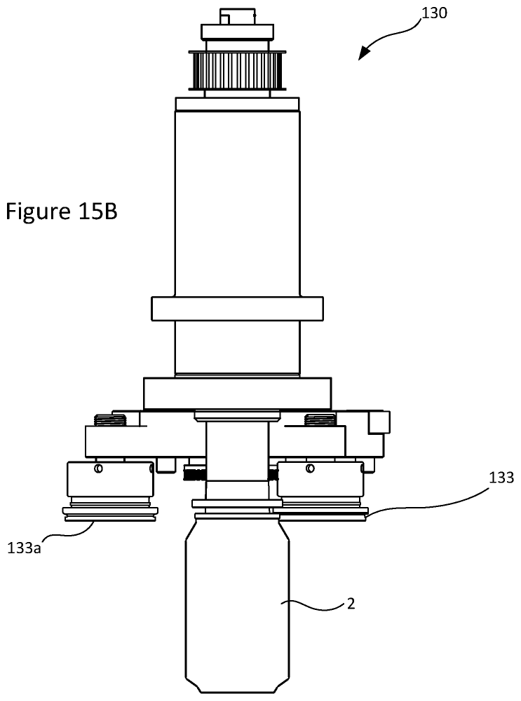

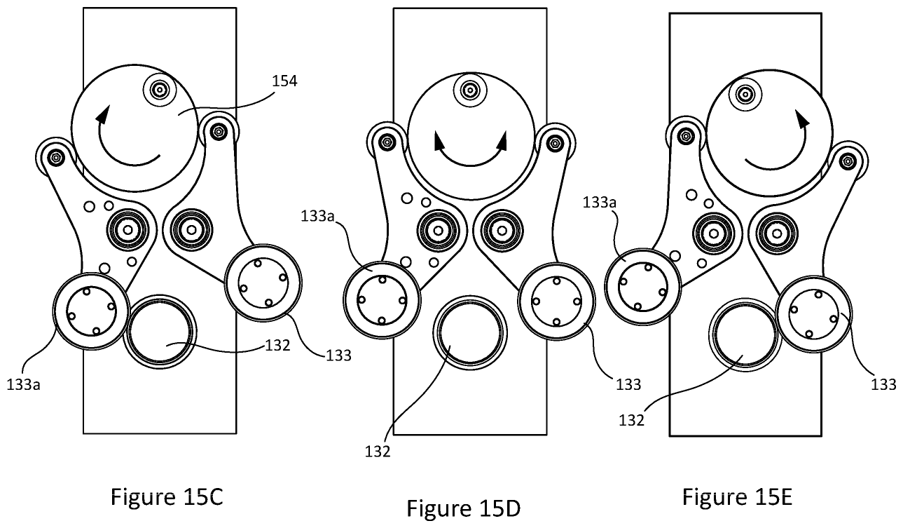

One embodiment of seamer 130 is shown in greater detail in FIGS. 15 to 15E. The seaming chuck 132 is mounted on a spindle assembly 150. Rotational motion of the spindle assembly 150 (and therefore of the seaming chuck 132, can body 2 and can-end 103) may be driven by a motor (not shown) via a suitable belt and pulley 151, or by any other suitable drive arrangement. In the embodiment shown, a motor drives the spindle via a toothed belt acting on pulley 151. The motor may be controlled (e.g. using a Variable Frequency Drive), or some other speed control may be provided, to ensure consistent rotational speed at the circumference of the can for a range of can-end diameters.

FIG. 15 shows that each seaming roller 133, 133a may be mounted on a pivot arm 152, 152a, each arranged to pivot about a pivot 153, 153a. Pivoting motion of the two arms may be driven by a cam 154 that rotates about a cam pivot 154a, driven by an actuator 154b. Each pivot arm 152, 152a may include a roller 155, 155a arranged to ride against the cam surface 155b.

The cam actuator 154b may be a servo motor directly attached to the cam. This allows accurate positioning of the seam rollers. In one embodiment, the servo may control the cam to apply the first operation seam roller 133 to the can-end for 2.5 turns of the can, and then to apply the second operation seam roller 133a to seal the can.

Using a servo motor for seam roller actuation ensures very precise and repeatable seam roller positioning, and using a pneumatic actuator for vertical positioning means the cans are under constant and quickly applied force. This constant force is helpful as the can size may change during seaming—in particular, the overall can height may change after the first seam roller has rolled the can-end.

While this embodiment uses one servo to power both seaming rollers 133, 133a via a cam, other arrangements may be used, e.g. independent motors for each seaming roller. Any suitable servo, stepper, hydraulic actuators may be used so long as the required positional accuracy can be provided.

The motion of the cam, pivot arms and seaming rollers is illustrated further in FIGS. 15C to 15E. In the neutral position of FIG. 15D, neither seaming roller 133, 133a is in contact with the can 2. In this position, a new can may be brought into position, or a seamed can may be removed from the seamer. This may be considered a disengaged position for both seaming rollers 133, 133a.

When a new can is in position, the cam will move from the neutral position of FIG. 15D to the position of FIG. 15E. This drives the first seaming roller 133 from its disengaged position to a fully engaged or end position. This completes the first stage of seaming (FIG. 14). The cam may then be moved from the position of FIG. 15E, back through the neutral position of FIG. 15D, to the position of FIG. 15C. This drives the second seaming roller 133a from its disengaged position to a fully engaged or end position. This completes the second stage of seaming to form the finished seam (FIG. 14A). The cam may then be returned to the neutral position of FIG. 15D for removal of the seamed can and entry of a further can to be seamed.

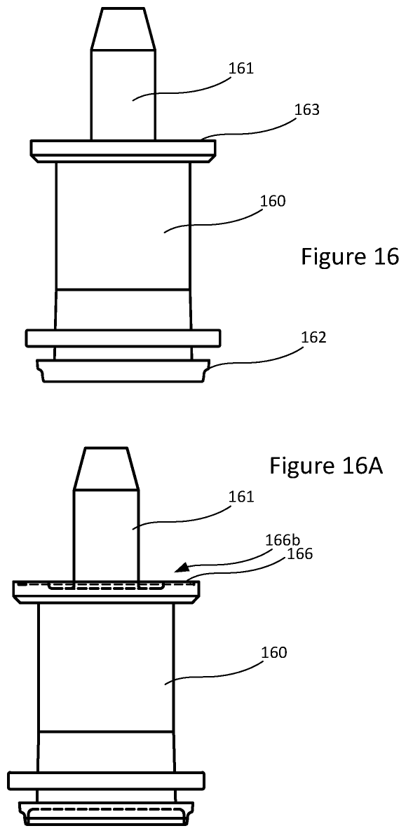

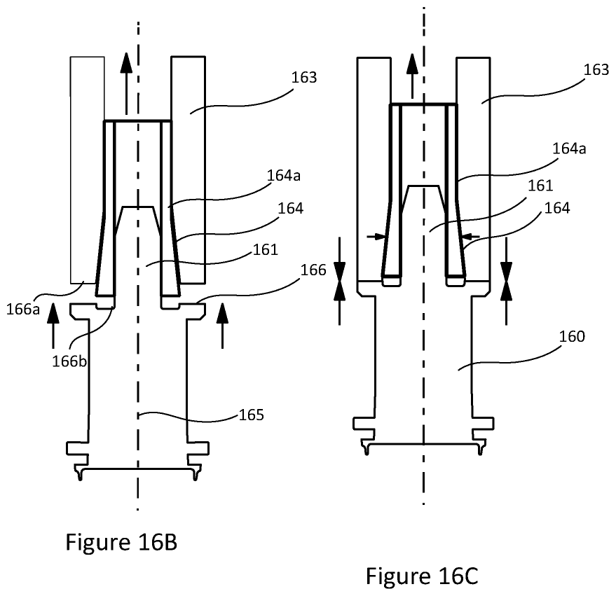

As illustrated in FIGS. 16 to 16C, the Applicant's system may allow interchanging of the seaming chuck. This allows the seamer to seam a variety of can profiles, types, dimensions etc.

FIG. 16 shows seaming chuck 132 formed integrally with or mounted on a body 160 and shaft 161. The chuck 132 has a profile 162 suited to seaming of a particular can profile or type. Other chucks with other profiles may be similarly formed with their own shafts 161. The chucks may then be interchanged for seaming of different can profiles or types. FIGS. 16B and 16C are cross-sectional views showing a chuck 132 being inserted into the seaming machine spindle 163. In this embodiment the spindle 163 is formed with a taper 164 (e.g. a standard machine taper such as an R8 or any other suitable machine taper). A collet or chuck holder 164a cooperates with the spindle 163 and with the taper 164. The chuck holder 164 may be moved within the spindle by any suitable mechanism, such as a drawbar. A shown in FIG. 16B, a chuck shaft 161 may be inserted into the chuck holder 164a, which is then retracted into the spindle 163. The tapers cooperate to lock the seaming chuck to the spindle assembly. This arrangement constrains the axes 165 of the seaming chuck 132 and spindle 163 to be colinear.

In alternative embodiments, the chuck may mount directly to the machine taper without an intermediate chuck holder.

One or more cooperating registration surfaces may also be provided in order to register the axial position (that is, the position along the axis) of the seaming chuck relative to the spindle 163. In the embodiment shown, a chuck registration surface 166 registers against a cooperating surface 166a of the spindle. An annular recess 166b may provide clearance for chuck holder 164a, and improve registration between the chuck and spindle.

This arrangement therefore allows very accurate and repeatable positioning of any one of a number of seaming chucks relative to the spindle. In some embodiments the chucks may be interchangeable while the seaming rollers are universal for a range of can profiles, types and/or sizes.

The Applicant's seaming system may also provide an automated or semi-automated calibration procedure, in order to calibrate the relative positions of the seaming rollers and seaming chuck. This calibration may be performed on commissioning a new machine, on startup, when changing the seaming chuck, and/or periodically during operation.

In some applications a final seam width is tightly defined, for example some seams are required to have a width of 1.14±0.04 mm. In general, final seam dimensions and tolerances may be governed by standards, manufacturer requirements etc. The Applicant's seamer and calibration process allow such tolerances and requirements to be met reliably and without expert intervention. In general, calibration of the second roller 133a (i.e. the roller than forms the final seam-FIG. 14A) may be more critical than the first roller. The dimensions and tolerances of the intermediate seam (FIG. 14) may also be governed by standards, manufacturer requirements etc.

The Applicant's seaming rollers and/or seaming chuck may be formed with a number of reference or calibration surfaces. Calibration may involve detection of the position of a seaming roller and/or seaming chuck. For example, in the above embodiment, calibration may involve detecting a position of a seaming roller relative to the seaming chuck, determining a calibration value, and using that calibration value to calibrate control of the cam 154.

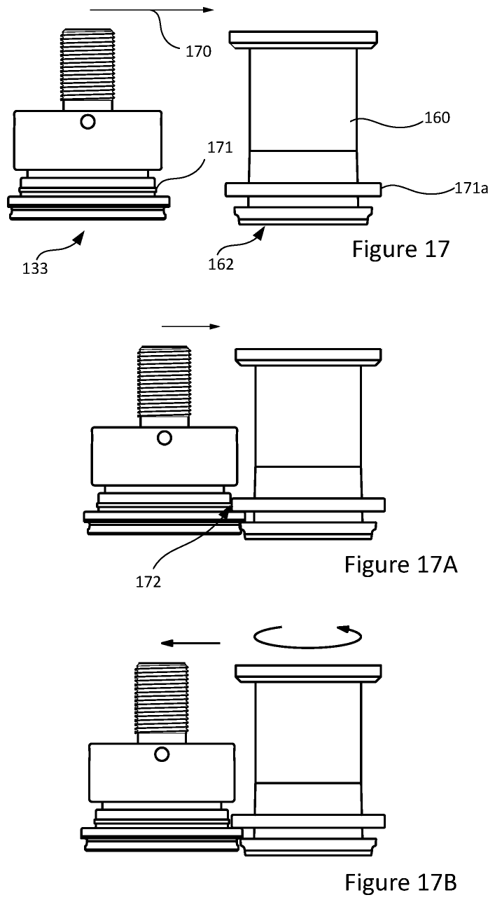

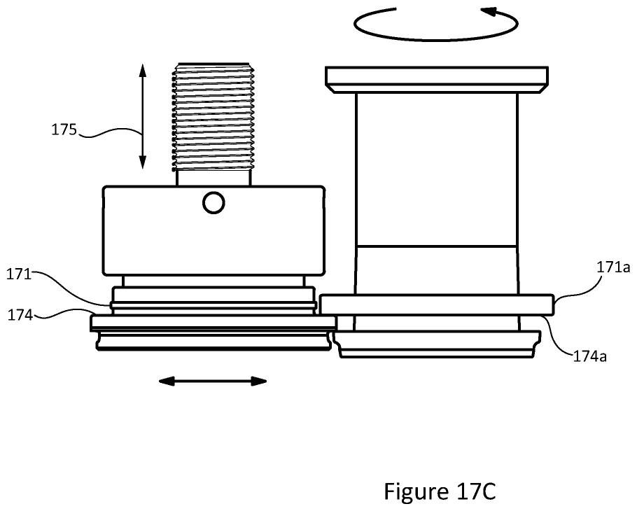

FIGS. 17 to 17C illustrate one embodiment of seamer calibration. In FIG. 17 a seaming roller 133 is moved 170 towards the seaming chuck. The seaming roller 133 includes a reference or calibration surface 171 and the seaming chuck includes a reference or calibration surface 171a. These surfaces may be provided by any suitable surface of each component—in the embodiment shown each is formed as a protruding ring, which may be precisely ground during manufacture. As shown in FIG. 17A, the reference or calibration surfaces 171, 171a will contact at a point 172. Contact may be sensed by any suitable means. In one embodiment, the formation of an electrical connection on contact may be sensed. However, any other suitable arrangement for determining a contact or a relative displacement between the seaming roller and seaming chuck may be used, including e.g. optical sensors, electrical contact sensors, electrical load sensors (e.g. sensing increased load on the roller servo 154b and/or a spinning seaming chuck on contact).

A calibration value may now be determined based on the sensed contact or displacement. This calibration value may be stored or used to correct an operating parameter. In one embodiment, an end position value defining the full engaged state of the seaming roller may be updated. In any case, the extent of motion of the seaming roller is controlled in accordance with the calibration process.

FIG. 17B shows an end point, or fully engaged operating position, for the seaming roller 133. Note that the roller is slightly backed off from the contact position of FIG. 17A.

The process of FIGS. 17-17C has therefore calibrated the transverse position of the roller relative to the chuck.

In further embodiments, two or more calibration positions may be used. For example, two or more calibrations may be performed at different positions of a seaming chuck. If square or rectangular cans are to be processed one or more calibration processes may be performed on each side and/or corner. In FIG. 17C a further calibration step may be performed to calibrate the vertical or axial position. The axial position may be adjusted and contact or a relative displacement between reference or calibration surfaces 174, 174a may be detected, by any of the methods mentioned above. An axial calibration value or required adjustment may now be determined based on the sensed contact or displacement. The axial position of the seaming roller 133 may be adjusted 175. However, in some embodiments, this calibration and/or adjustment of seaming roller vertical or axial position may be performed at the time of manufacturing. This relies on accurate and repeatable registration of the seaming chuck axial position (FIGS. 16B, 16C).

In further embodiments, calibration may be performed using a removable calibration widget or the like.

For example, one or more calibration widgets may be temporarily attached to the seaming spindle and/or seaming chuck and/or the seaming roller, with one or more of the reference or calibration surfaces on those widget(s).

The seamed can may be weighed for quality assurance and then exits the canning system.

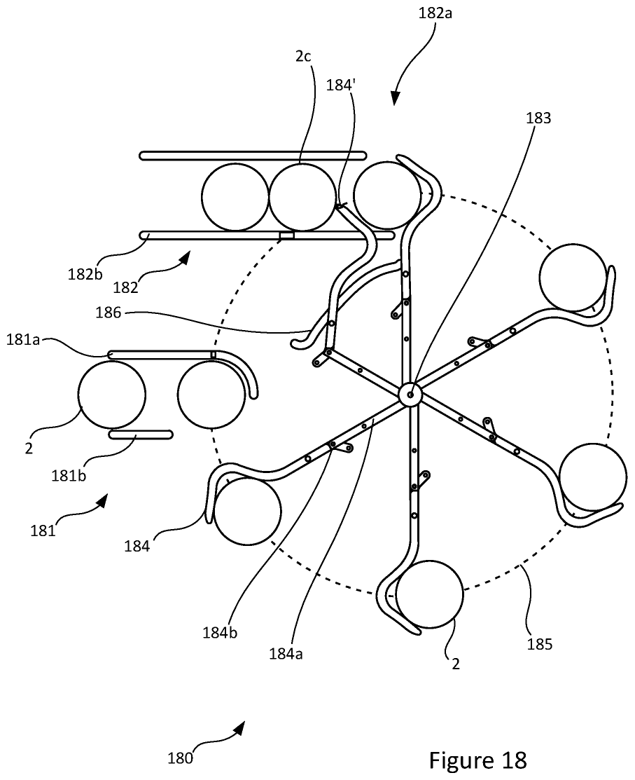

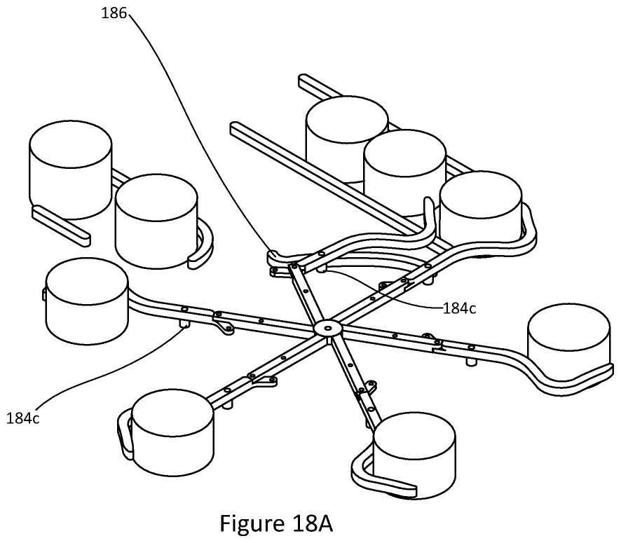

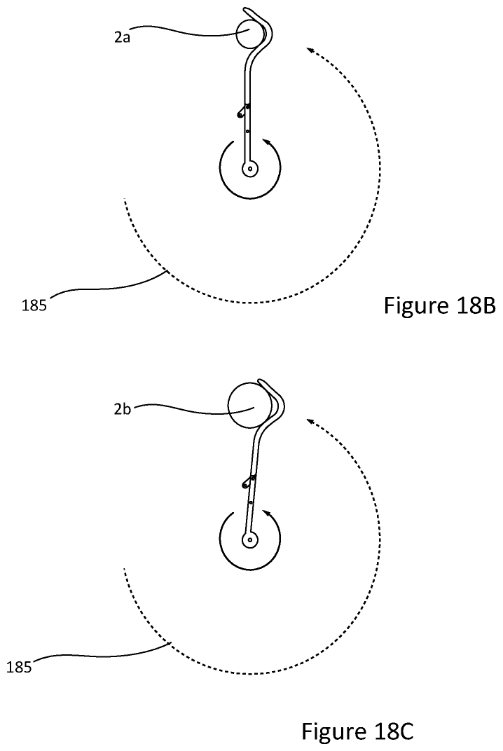

In general, any of the above systems may be incorporated into and/or linked by conveyors that move the cans through the canning system. Transport of various can sizes through the same canning system leads to challenges in reliably moving and accurately positioning cans. FIGS. 18 to 18C illustrate one embodiment of conveyor adapted for use with a range of container sizes and/or types.

FIG. 18 shows a conveyor 180 arranged to move can bodies 2 from an entry 181 to an exit 182. In this embodiment the conveyor 180 is in the form of a carousel conveyor, pivoting around a central pivot 183. However, the skilled reader will understand that aspects of this system may be adapted for other types of conveyors, including rotary conveyors, linear conveyors, rail conveyors etc.

Entry rails or guides 181a, 181b guide a can body into the entry position. In this position, a rotating container bearer 184 moves past the entry position, capturing a can body and moving it from the entry position onto a conveyor path 185. The conveyor bearer is offset in height relative to the entry rails 181a, 181b so that it may pass above or beneath them.

Each container bearer 184 may be mounted on a bearer carrier 184a at a spring-loaded pivot 184b. The container bearer is therefore biased to an extended position.

Each container bearer 184 may have a shape that positions and moves a round or cylindrical container along the conveyor path 185 (the conveyor path being the path followed by the center of the container). Further, each container bearer may be configured to do so for a range of container sizes. For example, FIG. 18B and FIG. 18C show the same container bearer 184 moving a small container 2a and a large container 2b along the same conveyor path 185. That is, the centre of each can is following the same conveyor path despite their different sizes. In the embodiment shown this is achieved using a generally V-shaped container bearer that contacts the can at two points on either side of the conveyor path. Other types of bearer may also be suitable. For example, bearers using pins or fingers that contact the container on each side of the conveyor path. In general, any bearer that accurately aligns containers of various sizes on the conveyor path may be used.

At an exit point 182a, the container contacts an exit rail or guide 182b. The container bearer is offset vertically such that it is allowed to pass the rail 182b (see FIG. 18A). In this position, a guide pin 184c contacts a bearer retraction guide rail 186, which is configured to cause the container bearer 184′ to retract, releasing can 2c into the exit rails. The guide pin 184c then exits the rail 186, allowing the container bearer to extend around the biased pivot 184b and to bring a new can 2 onto the conveyor path from the entry 181.

The position of a container axis or center is therefore known to lie along the conveyor path. The position of the container axis or center forward of its bearer depends on the size of that container. In general the size and/or type of the container may be known, input by a user or sensed by the system. A container type or code may be provided to the controller.

These conveying mechanisms may be incorporated into any of the Applicant's systems and any of the above system components, including entry A, pre-fill B, fill C, closure D, sealing E and exit F conveyors (FIG. 1), or the single conveyor system of FIG. 2. Further, these conveying mechanisms may be adapted for other canning or packaging systems.

Further, any appropriate methods may be used to determine and/or track container position. Such methods may be entirely predictive, based on knowledge of the system and the container. Other methods may be sensor-based, including the use of e.g. optical sensors. Still further systems may be hybrid predictive/sensor methods, based e.g. on system knowledge and sensed information, such as a container characteristic, container position at a particular time etc. Position of a container, or positions of a plurality of containers, may be determined based at least partly on the known or determined position of another container. Container characteristics may be known from a container type, container type identifier etc, may be entered by a user, determined by measurement (e.g. optical measurement) or determined based on reading a code (such as a barcode or similar) from the container. System actions, including movement of any component of the system may be controlled in accordance with the container characteristics, including e.g. movement of the fill head, fill conduit, seaming actuator, seaming rollers, prefill processes, closure system, sealing or seaming system etc.

The Applicant's control methods may be implemented using readily available computing devices. As used herein, the terms “computer” and “computing device” generally refer to devices that have a processor and non-transitory memory, as well as any data processor or any device capable of communicating with a network. Data processors include programmable general-purpose or special-purpose microprocessors, programmable controllers, application-specific integrated circuits (ASICs), programming logic devices (PLDs), system on chip (SOC) or system on module (SOM) (“SOC/SOM”), an ARM class CPU with embedded Linux or Android operating system or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

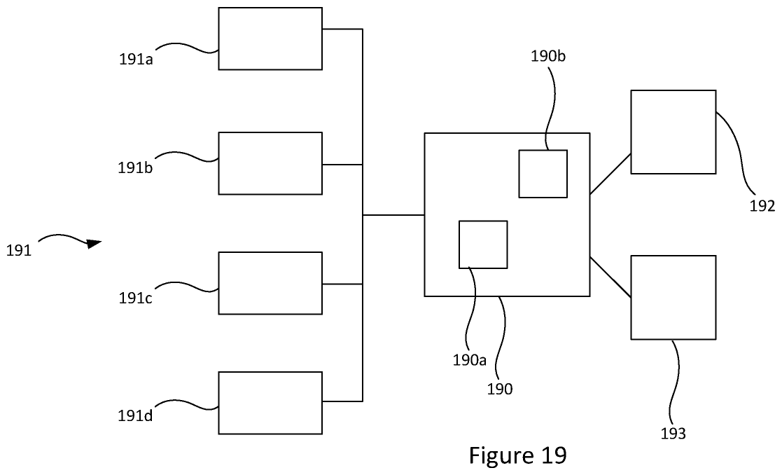

FIG. 19 shows one embodiment of a control system, that is arranged to control the entire canning system. The skilled reader will understand that this is merely an example, and a suitable control system may be implemented in any suitable arrangement of one or more controllers and sub-controllers etc.

A system controller 190, such as a computing device, may include a processor 190a and memory 190b. Data may be obtained from one or more sensors 191, which may include one or more container position sensors 191a, one or more system position sensors 191b (e.g. for monitoring the position of a particular conveyor, container bearer, servo, actuator, fill head, fill conduit, or any other moving component of the system), fill sensors 191c, including e.g. any of the sensors shown in FIG. 9A, weight sensors 191d, code readers 191d, such as optical barcode or QR code readers, and any other suitable or desired system sensors. Based on the sensor data, the controller 190 may control movement of any moving system components 192 (including e.g. conveyor systems, actuators, moving parts of the pre-fill, fill, closure and seaming systems) and valves 193 (including e.g. valves for control of pre-clean and pre-purge gases, valves in the fill system etc).

The Applicant's system has been described mainly with reference to packaging sparkling or brewed beverages, using CO₂ in the filling system. However, other inert gases, such as nitrogen, may be suitable in some applications.

All of the above systems, apparatuses and/or methods may be combined into a single packaging line. However, elements of the Applicant's system may be used separately from the rest of the system described above. For example, the Applicant's seamer may be incorporated into existing canning lines that otherwise operate differently to those described above.

The Applicant's system not only reduces exposure to the atmosphere, but also allows individual containers to be traced through the entire process, with known progress through a series of interlinking conveyors and stations with a known can at each position. This allows the machine to mark individual cans and capture data points for each can through the process (time, batch, pressures, temperatures, etc.). This data can be stored locally and used to monitor quality, update control parameters etc.

The invention has been described principally with reference to canning of beverages. Various can sizes and types may be used, including standard beverage can types, widget cans (arranged to release gas when the can is opened) etc. Further, aspects of the invention are more broadly applicable, to canning of foodstuffs, other perishable materials or other contents. Aspects of the invention may also be applicable to packaging of contents in containers other than cans, including jars, bottles etc.

Round, oval, square or rectangular cans may be used with some elements of the Applicant's system. For example, any such cans may be filled and seamed (with suitable servo controls of the seaming roller position).

Various sensor arrangements have been described. Sensors may be combined, for example where temperature and pressure are to be determined, separate sensors or a combine T/P sensor may be used.

While the present invention has been illustrated by the description of the embodiments thereof, and while the embodiments have been described in detail, it is not the intention of the Applicant to restrict or in any way limit the scope of the appended claims to such detail. Further, the above embodiments may be implemented individually, or may be combined where compatible. Additional advantages and modifications, including combinations of the above embodiments, will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1.-7. (canceled)

8. A can seaming system configured to form a seam between a can body and a closure to create a seamed can, the system including:
a spindle assembly including a seaming chuck mounted on a seaming spindle, the spindle assembly including a first reference surface; and
a seaming roller assembly including:
one or more seaming rollers configured to cooperate with the seaming chuck to form a seam between a can body and a can end, the one or more seaming rollers each configured to move through a range of motion from a disengaged position to an end position;
a second reference surface; and
one or more actuators configured to move each of the one or more seaming rollers through its range of motion;
a calibration sensor configured to sense a relative position between the first reference surface of the spindle assembly and the second reference surface of the seaming roller assembly; and
a controller configured to control the one or more actuators based at least in part on the sensed relative position.

9. The can seaming system of claim 8, wherein the calibration sensor includes one or more of:
an electric connection sensor;
a load sensor; and
an optical sensor.

10. The can seaming system of claim 8, further including a third reference surface on the spindle assembly and a fourth reference surface on the seaming roller assembly, the calibration sensor being configured to sense a second relative position between the third reference surface and the fourth reference surface, the controller being configured to adjust the relative vertical positions of the spindle assembly and/or seaming roller assembly based on the second relative position.

11. The can seaming system of claim 8, wherein the system is configured to seam two or more types or sizes of can, the spindle assembly of the system including:
a seaming spindle having a rotational axis; and
two or more interchangeable seaming chucks, wherein:
each of the two or more seaming chucks is configured for use with a different can type; and
each of the two or more seaming chucks is configured for mounting to the seaming spindle;
wherein the one or more seaming rollers of the seaming roller assembly are configured to cooperate with the mounted seaming chuck to form a seam between the can body and the closure.

12. The can seaming system of claim 11, wherein the seaming spindle incorporates a machine taper.

13. The can seaming system of claim 12, incorporating a seaming chuck holder configured to mount to the machine taper, each seaming chuck being configured to mount to the seaming chuck holder.

14. The can seaming system of claim 11, configured to align an axis of a mounted seaming chuck with the rotational axis of the spindle.

15. The can seaming system of claim 11, wherein each of the two or more seaming chucks includes a registration surface configured to bear against a cooperating registration surface of the seaming spindle, to register a position of that seaming chuck along the rotational axis of the seaming spindle.

16. The can seaming system of claim 8, wherein the one or more seaming rollers are each configured to move through a range of motion from a disengaged position to an end position; the system including one or more actuators configured to move each of the one or more seaming rollers through its range of motion.

17. The can seaming system of claim 8, including a single actuator configured to rotate a cam that acts to move each of the one or more seaming rollers through its range of motion.

18. The can seaming system of claim 17, wherein the single actuator is a servo motor.

19. The can seaming system of claim 8, including two or more seaming rollers.

20. The can seaming system of claim 19, wherein the two or more seaming rollers are arranged for double seaming.

21. (canceled)

22. The can seaming system of claim 8, including a feed arrangement configured to move filled can bodies and closures into a seaming position.

23. The can seaming system of claim 8, configured for relative vertical movement between the can and seaming chuck, to bring the can closure into or out of contact with the seaming chuck.

24. The can seaming system of claim 8, further including a can conveyor, the can conveyor including:
a plurality of can bearers, each being configured to bear a single can along the conveyor path, wherein each of the plurality of can bearers is configured for use with cans of different sizes within a range of acceptable can sizes, each can bearer configured to align a center or axis of any such can with the same conveyor path.

25. The can seaming system of claim 24, wherein each can bearer is configured to contact a can at two points, one on each side of the conveyor path.

26. (canceled)

27. A The can seaming system of claim 8, further including a can conveyor, the can conveyor including:
one or more bearer carriers and a plurality of can bearers, wherein the one or more bearer carriers are configured to move the plurality of can bearers such that, in use, one or more cans are moved along a conveyor path,
wherein:
each of the plurality of can bearers is configured to bear a single can along the conveyor path; and
each of the plurality of can bearers is mounted for rotational movement relative to its respective bearer carrier, for entry and/or exit of a can to/from the can conveyor.

28. The can conveyor of claim 27, including a guide rail and each can bearer including a guide element that rides along the guide rail to cause the rotational movement.

29.-35. (canceled)

36. The can seaming system of claim 8, further including a can closure system, including:
a can feed arrangement configured to move filled cans into a closure application position;
a closure head arranged to apply a closure to a filled can in the closure application position; and
a closure feeder arranged to feed closures to the closure head, the closure feeder including an intermediate closure holder and a bulk closure holder, wherein the intermediate closure holder is configured to hold one or more closures, to receive closures from the bulk closure holder and feed closures to the closure head.

37.-46. (canceled)
